(19) United States
(12) Patent Application Publication
(10) Pub. No.: US 2024/0384978 A1
(43) Pub. Date: Nov. 21, 2024

(54) Laser Interferometer And Method Of Adjusting Optical Axis Of Laser Interferometer

(71) Applicant: SEIKO EPSON CORPORATION, Tokyo (JP)

(72) Inventors: Jun KITAGAWA, Matsumoto (JP); Kohei YAMADA, Shiojiri (JP); Nobuhito HAYASHI, Chino (JP)

(21) Appl. No.: 18/664,376

(22) Filed: May 15, 2024

(30) Foreign Application Priority Data
May 19, 2023 (JP) 2023-083266

(51) Int. Cl. G01B 9/02001; G01B 9/02

(52) U.S. Cl. CPC G01B 9/02007; G01B 9/02049; G01B 2290/70

(57) ABSTRACT

A laser interferometer includes an optical interference unit as a non-coaxial optical system including a laser source for emitting a laser beam, a light modulator for modulating a frequency of the laser beam to generate reference light, a light receiving element for receiving object light generated in response to irradiation of an object with the laser beam, and the reference light to output a received light signal, a first aperture element disposed on a light path entering the light receiving element, and for detecting a positional deviation of an optical axis of the object light from an optical axis of the reference light, and an angular deviation detection unit for detecting an angular deviation of the optical axis of the object light from the optical axis of the reference light based on the received light signal, and an instruction unit for issuing an instruction to change a relative arrangement between the optical interference unit and the object based on a detection result of the positional deviation and a detection result of the angular deviation.

The present application is based on, and claims priority from JP Application Serial Number 2023-083266, filed May 19, 2023, the disclosure of which is hereby incorporated by reference herein in its entirety.

### BACKGROUND

### 1. Technical Field

The present disclosure relates to a laser interferometer and a method of adjusting an optical axis of the laser interferometer.

### 2. Related Art

JP-A-2007-285898 discloses a laser vibrometer as an apparatus for measuring a vibration velocity of an object. In this laser vibrometer, an object to be measured is irradiated with a laser beam, and the vibration speed is measured based on scattered laser beam subjected to a Doppler shift.

The laser vibrometer described in JP-A-2007-285898 includes a vibrator element that generates a predetermined frequency. The vibrator element shifts a frequency of an incident laser beam based on the vibration frequency thereof, and generates a reflected laser beam having a frequency different from that of the incident laser beam. In the laser vibrometer, the reflected laser beam is used as reference light. Further, by receiving light obtained by multiplexing the scattered laser beam derived from the object to be measured and the reference light with a photodetector, a beat signal is electrically extracted. Then, the vibration speed of the object to be measured is measured from the beat signal.

However, in a laser source, laser oscillation becomes unstable in some cases due to entry of return light. The return light refers to the laser beam that is emitted from the laser source, and is then reflected by an optical component to return toward the laser source despite intentions. When the laser oscillation becomes unstable, the quality of the laser beam decreases. Accordingly, in the laser vibrometer, a decrease in S/N ratio (signal-to-noise ratio), and discontinuity in phase of the laser beam are incurred. As a result, the measurement accuracy of the vibration velocity of the object decreases.

A non-coaxial optical system is known as a technique for suppressing the return light. The non-coaxial optical system is an optical system in which a reflection surface of an optical component is inclined such that light (incident light) incident on the optical component and light (reflected light) that is the light reflected by the optical component propagate along respective axes different from each other. By inclining the reflecting surface, even when a part of the reflected light returns toward the laser source, the reflected light returns to a position deviated from the laser source. Therefore, it is possible to prevent the return light from entering the light exit portion of the laser source.

When such a non-coaxial optical system as described above is applied to the laser vibrometer, it is conceivable that it is possible to prevent the laser oscillation from being destabilized due to the return light.

JP-A-2007-285898 is an example of the related art.

When the non-coaxial optical system is applied to the laser vibrometer described in JP-A-2007-285898, the scattered laser beam (object light) derived from the object to be measured and the reference light are multiplexed and received by the photodetector. At this time, when the optical axis of the object light and the optical axis of the reference light are nonparallel to each other, interference occurs in a region (overlapping region) where both beams overlap each other. When the optical axes of the beams are parallel to each other, there is no difference in optical path length at each point of the overlapping region, and thus no difference occurs in the interference state. However, when the optical axes of the beams are nonparallel to each other, a difference occurs in the optical path length at each point in the overlapping region, and a difference also occurs in the interference state. Therefore, when observation is performed on an observation surface crossing the respective optical axes, bright and dark fringes (interference fringes) are observed as a result.

Since the photodetector is placed on the observation surface as a result, the intensities of the interference fringes are integrated, averaged, and then detected. Therefore, the intensities of the bright and dark fringes cancel out each other out, and the S/N ratio of a received light signal decreases.

Therefore, it is required to adjust the optical axes so as to prevent the interference fringes from being generated in the overlapping region in the non-coaxial optical system to thereby prevent the decrease in the S/N ratio in the received light signal.

### SUMMARY

A laser interferometer according to an application example of the present disclosure includes
an optical interference unit as a non-coaxial optical system including
   a laser source configured to emit a laser beam,
   a light modulator that is configured to modulate a frequency of the laser beam to generate reference light,
   a light receiving element configured to receive object light generated in response to irradiation of an object with the laser beam, and the reference light to output a received light signal,
   a first aperture element disposed on a light path through which the object light and the reference light enter the light receiving element, and configured to detect a positional deviation of an optical axis of the object light from an optical axis of the reference light, and
   an angular deviation detection unit configured to detect an angular deviation of the optical axis of the object light from the optical axis of the reference light based on the received light signal, and
an instruction unit configured to issue an instruction to change a relative e arrangement between the optical interference unit and the object based on a detection result of the positional deviation and a detection result of the angular deviation.

A method of adjusting an optical axis of a laser interferometer according to an application example of the present disclosure is a method of adjusting an optical axis of a laser interferometer including
an optical interference unit as a non-coaxial optical system including
   a laser source configured to emit a laser beam,
   a light modulator that is configured to modulate a frequency of the laser beam to generate reference light,
   a light receiving element configured to receive object light generated in response to irradiation of an object with the laser beam, and the reference light to output a received light signal,
   a first aperture element disposed on a light path through which the object light and the reference light enter the light receiving element, and configured to detect a positional deviation of an optical axis of the object light from an optical axis of the reference light, and
   an angular deviation detection unit configured to detect an angular deviation of the optical axis of the object light from the optical axis of the reference light based on the received light signal, and includes
issuing an instruction to change a relative arrangement between the optical interference unit and the object based on a detection result of the positional deviation and a detection result of the angular deviation, and
changing the arrangement based on the instruction.

### BRIEF DESCRIPTION OF THE DRAWINGS

FIG. 1 is a functional block diagram showing a laser interferometer according to an embodiment.

FIG. 2 is a schematic configuration diagram showing a sensor head unit provided to the laser interferometer shown in FIG. 1.

FIG. 3 is a perspective view showing a configuration example of a vibrator element shown in FIG. 2.

FIG. 4 is a perspective view showing another configuration example of the vibrator element shown in FIG. 2.

FIG. 5 is a perspective view of a first aperture element and a light receiving element shown in FIG. 2 as viewed from an analyzer side.

FIG. 6 is a table listing images of a positional deviation and an angular deviation between reference light and object light generated in the light receiving element shown in FIG. 2, and influences thereof.

FIG. 7 is a waveform illustrating an example of an AC component of a received light signal.

FIG. 8 is a flowchart representing a configuration of a method of adjusting an optical axis of the laser interferometer according to the embodiment.

FIG. 9 is a perspective view schematically showing an example in which an irradiation position with the object light shown in FIG. 5 moves in six directions, namely directions a through f.

FIG. 10 is a graph showing temporal changes of an X coordinate and a Y coordinate in a normalized coordinate system (X, Y) when the irradiation position with the object light moves in the six directions, the directions a through f shown in FIG. 9.

FIG. 11 is a diagram schematically showing an arrangement example when an AC amplitude shown in FIG. 7 is maximized.

FIG. 12 is a diagram schematically showing an arrangement example when the AC amplitude becomes smaller than that in the arrangement example shown in FIG. 11.

FIG. 13 is a waveform illustrating an example of an AC amplitude and a DC level of a received light signal observed in the arrangement example shown in FIG. 12.

FIG. 14 is a schematic configuration diagram illustrating a part of an interference optical system provided to a laser interferometer according to a first modified example.

FIG. 15 is a perspective view showing a first aperture element, an aperture, and a light receiving element shown in FIG. 14.

FIG. 16 is a flowchart representing a configuration of a method of adjusting an optical axis of a laser interferometer according to the first modified example.

FIG. 17 is a schematic configuration diagram showing a part of an interference optical system provided to a laser interferometer according to a second modified example.

FIG. 18 is a perspective view showing a first aperture element, a second aperture element and a light receiving element shown in FIG. 17.

FIG. 19 is a flowchart representing a configuration of a method of adjusting an optical axis of a laser interferometer according to the second modified example.

FIG. 20 is a schematic configuration diagram showing the interference optical system provided to the laser interferometer according to the second modified example shown in FIG. 17, and is a diagram in which three examples different in light trace of the object light from each other are compared with each other.

FIG. 21 is a schematic configuration diagram showing a part of an interference optical system provided to a laser interferometer according to a third modified example.

FIG. 22 is a flowchart representing a configuration of a method of adjusting an optical axis of a laser interferometer according to the third modified example.

FIG. 23 is a schematic configuration diagram showing a part of an interference optical system provided to a laser interferometer according to a fourth modified example.

FIG. 24 is a schematic configuration diagram showing a part of an interference optical system provided to a laser interferometer according to a fifth modified example.

### DESCRIPTION OF EMBODIMENTS

A laser interferometer and a method of adjusting an optical axis of the laser interferometer according to the present disclosure will hereinafter be described in detail based on an embodiment illustrated in the accompanying drawings.

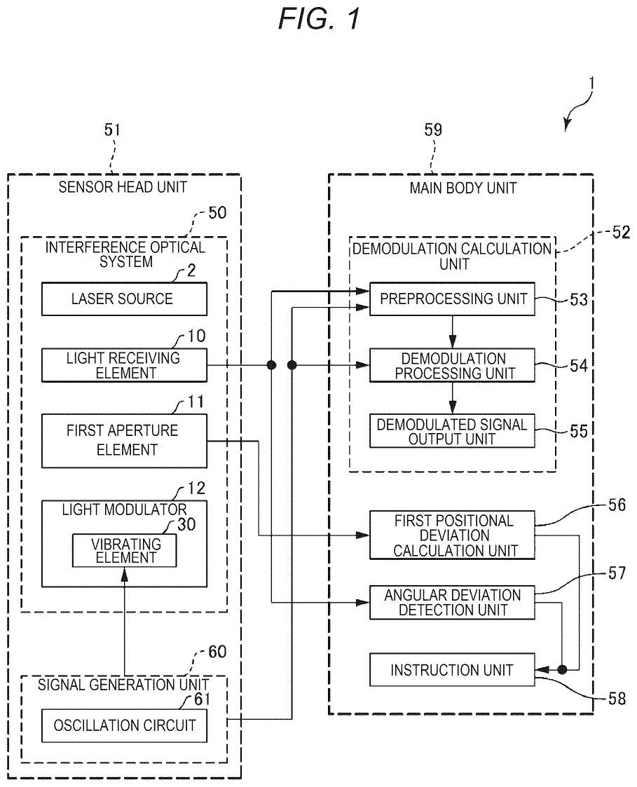

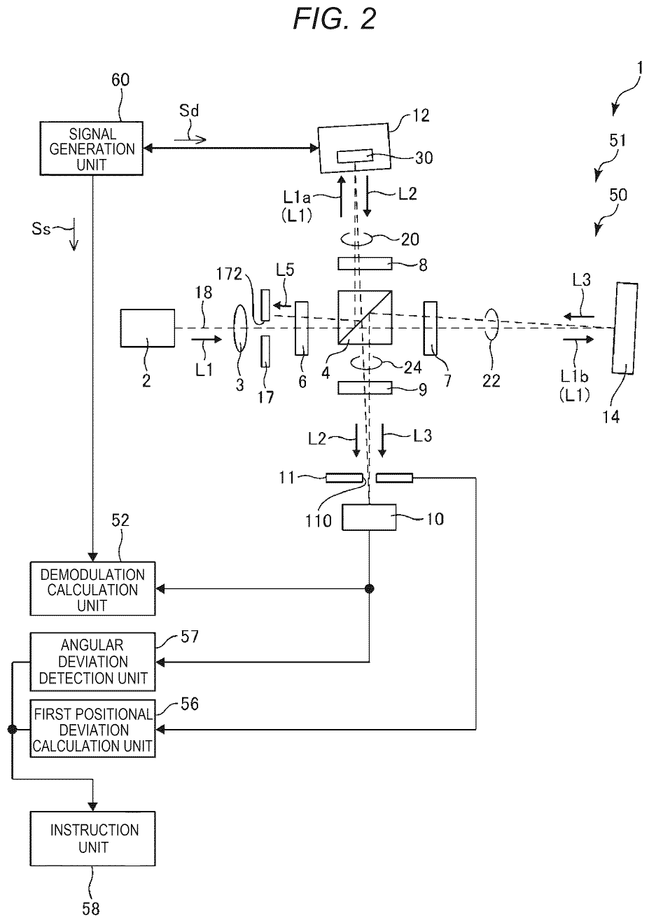

FIG. 1 is a functional block diagram showing a laser interferometer 1 according to the embodiment. FIG. 2 is a schematic configuration diagram showing a sensor head unit 51 provided to the laser interferometer 1 shown in FIG. 1.

The laser interferometer 1 shown in FIG. 1 irradiates an object 14 and a light modulator 12 shown in FIG. 2 with a laser beam. Then, the laser beam emitted from the object 14 and the laser beam emitted from the light modulator 12 are made to interfere with each other, and the interference light is received by the light receiving element 10. Then, information derived from an object 14 is extracted using optical heterodyne interferometry, and the displacement and speed of the object 14 are measured based on the information.

The laser interferometer 1 shown in FIG. 1 includes the sensor head unit 51 and a main body unit 59.

The sensor head unit 51 shown in FIG. 1 includes an interference optical system 50 (optical interference unit) and a signal generation unit 60. The sensor head unit 51 is easily reduced in size and weight, and is easily provided with portability and installation easiness, and can therefore be disposed, for example, near the object 14 shown in FIG. 2, which is an object to be measured by the laser interferometer 1.

The main body unit 59 includes a demodulation calculation unit 52, a first positional deviation calculation unit 56, an angular deviation detection unit 57, and an instruction unit 58. The main body unit 59 can be integrated with the sensor head unit 51, but can be disposed at a distance from the sensor head unit 51, and can be a stationary unit which can be housed in, for example, a rack, or can also be a portable unit which can be carried around. Further, at least one of the functional units described above and provided to the main body unit 59 can be disposed in the sensor head unit 51.

### 1. Laser Interferometer

The sensor head unit 51 shown in FIG. 1 includes the interference optical system 50 and the signal generation unit 60.

### 1.1. Interference Optical System

The interference optical system 50 shown in FIG. 2 is a Michelson interference optical system. The interference optical system 50 includes a laser source 2, a collimator lens 3, a blocking element 17, a light splitter 4, a half wave plate 6, a quarter wave plate 7, a quarter wave plate 8, an analyzer 9, a light receiving element 10, a first aperture element 11, and a light modulator 12.

The laser source 2 emits outgoing light L1 which is a laser beam. The light receiving element 10 converts the interference light received into an electric signal. The light modulator 12 includes a vibrating element 30, and changes the frequency of the outgoing light L1 to generate reference light L2 which is a laser beam including a modulation component. The modulation component is a variation in the frequency component to be added to the outgoing light L1 by the light modulator 12. The outgoing light L1 incident on the object 14 is reflected as object light L3 which is a laser beam including a sample-derived component derived from the object 14. The sample-derived component is a Doppler signal associated with a displacement of the object 14, and is the variation in the frequency component added to the outgoing light L1.

A light path connecting the light splitter 4 and the laser source 2 is referred to as a light path 18. A light path connecting the light splitter 4 and the light modulator 12 is referred to as a light path 20. A light path connecting the light splitter 4 and the object 14 is referred to as a light path 22. A light path connecting the light splitter 4 and the light receiving element 10 is referred to as a light path 24. It should be noted that the “light path” in the present specification represents a path along which light travels, and which is set between optical components.

On the light path 18, the half wave plate 6, the blocking element 17, and the collimator lens 3 are arranged in this order from the light splitter 4 side. The quarter wave plate 8 is disposed on the light path 20. The quarter wave plate 7 is disposed on the light path 22. On the light path 24, the analyzer 9 and the first aperture element 11 are arranged in this order from the light splitter 4 side.

The outgoing light L1 emitted from the laser source 2 passes through the light path 18 and is split into two by the light splitter 4. First split light L1a, which is a part of the outgoing light L1, passes through the light path 20 and enters the light modulator 12. Further, second split light L1b, which is another part of the outgoing light L1, passes through the light path 22 and enters the object 14. The reference light L2 generated by the light modulator 12 shifting the frequency passes through the light path 20 and the light path 24 and enters the light receiving element 10. The object light L3 generated by reflection on the object 14 passes through the light path 22 and the light path 24 and enters the light receiving element 10.

It should be noted that the “light path” in the present specification represents a path along which light travels, and which is set between optical components. Further, the “optical axis” described later represents the central axis of a light flux traveling along the light path.

In the interference optical system 50 as described above, the phase information of the object 14 is obtained using the optical heterodyne interferometry. Specifically, two light beams (the reference light L2 and the object light L3) slightly different in frequency from each other are made to interfere with each other, and the phase information is extracted from the interference light obtained. Then, the displacement of the object 14 is obtained from the phase information in the demodulation calculation unit 52 described later. According to the optical heterodyne interferometry, when the phase information is extracted from the interference light, the phase information is hardly affected by disturbance, in particular, the influence of the stray light which becomes noise, and high robustness is provided.

The interference optical system 50 forms a non-coaxial optical system. In the non-coaxial optical system, an optical axis of the first split light L1a and an optical axis of the reference light L2 passing through the light path 20 are shifted from each other. Further, an optical axis of the second split light L1b and an optical axis of the object light L3 passing through the light path 22 are also shifted from each other. According to such a non-coaxial optical system, even when the reference light L2 is reflected by the light splitter 4 and then directed toward the laser source 2 as the return light L5 despite intentions, the reference light L2 temporarily reaches a position deviated from the exit portion of the outgoing light L1 as a result. In addition, when the object light L3 is transmitted through the light splitter 4 and then travels toward the laser source 2 as the return light L5, the object light L3 also reaches a position deviated from the exit portion of the outgoing light L1. Therefore, it is possible to prevent the laser oscillation in the laser source 2 from being destabilized. It should be noted that the exit portion refers to a surface from which the outgoing light L1 is emitted.

The constituents of the interference optical system 50 will hereinafter be further described.

### 1.1.1. Laser Source

The laser source 2 is a laser source that emits the outgoing light L1 having coherency. As the laser source 2, a light source having a line width no higher than the MHz band is preferably used. Specifically, there can be cited gas lasers such as a He—Ne laser, semiconductor laser elements such as a distributed feedback-laser diode (DFB-LD), a fiber Bragg grating laser diode (FBG-LD), a vertical cavity surface emitting laser (VCSEL), and a Fabry-Perot laser diode (FP-LD), and so on.

The laser source 2 is particularly preferably a semiconductor laser element. This makes it possible to particularly reduce the size of the laser source 2. Therefore, it is possible to reduce the laser interferometer 1 in size. In particular, in the laser interferometer 1, the reduction in size and weight of the sensor head unit 51 housing the interference optical system 50 is achieved, which useful in that it is possible to improve operability of the laser interferometer 1 such as a degree of freedom in installing the sensor head unit 51.

### 1.1.2. Collimating Lens

The collimator lens 3 is an optical element disposed between the laser source 2 and the light splitter 4, and an aspherical lens can be cited as an example thereof. The collimator lens 3 parallelizes the outgoing light L1 emitted from the laser source 2. It should be noted that when the outgoing light L1 emitted from the laser source 2 is sufficiently collimated, for example, when a gas laser such as a He—Ne laser is used as the laser source 2, the collimator lens 3 can be omitted.

On the other hand, when the laser source 2 is a semiconductor laser element, it is preferable to provide the collimator lens 3. Accordingly, since the outgoing light L1 turns to collimated light, it is possible to prevent an increase in size of various optical components that receive the outgoing light L1, and it is possible to achieve the reduction in size of the laser interferometer 1.

The outgoing light L1, which has turned to the collimated light, passes through the half wave plate 6 to thereby be converted into linearly polarized light having an intensity ratio between P-polarized light and S-polarized light of, for example, 50:50, and enters the light splitter 4.

### 1.1.3. Blocking Element

The blocking element 17 is an aperture disposed between the collimator lens 3 and the light splitter 4. The blocking element 17 has an aperture 172 provided corresponding to the light path 18. As shown in FIG. 2, the blocking element 17 more reliably prevents the return light L5 from entering the laser source 2. It should be noted that it is sufficient for the blocking element 17 to be a member including a slit, a pin hole, or the like, and the structure thereof is not particularly limited. In addition, it is sufficient for the blocking element 17 to be provided as necessary, and the blocking element 17 can be omitted when the incidence of the return light L5 on the exit portion can be prevented without the blocking element 17.

### 1.1.4. Light Splitter

The light splitter 4 is a polarization beam splitter disposed between the laser source 2 and the light modulator 12 and between the laser source 2 and the object 14. The light splitter 4 has a function of transmitting the P-polarized light and reflecting the S-polarized light. Due to this function, the light splitter 4 splits the outgoing light L1 into the first split light L1a that is the reflected light by the light splitter 4 and the second split light L1b that is transmitted light by the light splitter 4.

The first split light L1a, which is the S-polarized light reflected by the light splitter 4, is converted into circularly polarized light by the quarter wave plate 8, and enters the light modulator 12. The first split light L1a incident on the light modulator 12 is subjected to a frequency shift by fₘ [Hz], and is reflected as the reference light L2. Therefore, the reference light L2 includes a modulation component of the frequency fₘ [Hz]. The reference light L2 is converted into P-polarized light when passing through the quarter wave plate 8 once again. The P-polarized light as the reference light L2 is transmitted through the light splitter 4 and the analyzer 9 and enters the light receiving element 10.

The second split light L1b, which is the P-polarized light transmitted through the light splitter 4, is converted by the quarter wave plate 7 into the circularly polarized light, and then enters the object 14 in a moving state. The second split light L1b incident on the object 14 is subjected to a Doppler shift by fa [Hz] and is reflected as the object light L3. Accordingly, the object light L3 includes the sample-derived component of the frequency fa [Hz]. The object light L3 is converted into S-polarized light when passing through the quarter wave plate 7 once again. The S-polarized light as the object light L3 is reflected by the light splitter 4, passes through the analyzer 9, and then enters the light receiving element 10.

Since the outgoing light L1 has coherency, the reference light L2 and the object light L3 enter the light receiving element 10 as interference light. Accordingly, in other words, the light splitter 4 has a function of splitting the outgoing light L1 into a part (the first split light L1a) and another part (the second split light L1b), a function of irradiating the light modulator 12 with the first split light L1a and irradiating the object 14 with the second split light L1b, and a function of mixing the reference light L2 returning from the light modulator 12 and the object light L3 returning from the object 14. Accordingly, since the laser beam can be split and mixed by the light splitter 4, space saving of the interference optical system 50 can be achieved, which can contribute to the reduction in the size of the laser interferometer 1.

It should be noted that instead of the polarization beam splitter, a non-polarizing beam splitter can be used. In this case, since the half wave plate 6, the quarter wave plate 7, the quarter wave plate 8, and so on become unnecessary, the reduction in size of the laser interferometer 1 due to the reduction in the number of the components can be achieved. Further, it is possible to arrange to use a light splitter other than the beam splitter.

### 1.1.5. Analyzer

Since the S-polarized light and the P-polarized light perpendicular to each other are independent of each other, a beat caused by the interference does not appear only by simply superimposing the S-polarized light and the P-polarized light. Therefore, a light wave obtained by superimposing the S-polarized light and the P-polarized light is made to pass through the analyzer 9 inclined by 45° with respect to both the S-polarized light and the P-polarized light. By using the analyzer 9, it is possible to transmit light beams having a component common thereto to thereby cause the interference. As a result, in the analyzer 9, the reference light L2 and the object light L3 interfere with each other, and the interference light having a frequency of |fₘ-f_{d}| [Hz] is generated.

### 1.1.6. Light Receiving Element

When the interference light enters the light receiving element 10, the light receiving element 10 outputs a photocurrent (a received light signal) corresponding to the intensity of the interference light. By demodulating the sample-derived component from the light receiving signal by a method described later, it is possible to finally obtain the movement, that is, the displacement and the velocity of the object 14. As the light receiving element 10, there can be cited, for example, a photodiode. It should be noted that it is sufficient for what is received by the light receiving element 10 to be light including the sample-derived component and a modulation component, but is not limited to such interference light of the reference light L2 including the modulation component and the object light L3 including the sample-derived component as described above. In addition, “demodulating a sample-derived component from a received light signal” in the present specification includes demodulating the sample-derived component from various signals into which the photocurrent (the received light signal) is converted.

### 1.1.7. Light Modulator

Then, the light modulator 12 including the vibrating element 30 will be described.

The light modulator 12 shown in FIG. 2 includes the vibrating element 30. The vibrating element 30 vibrates in response to the drive signal Sd. Further, the vibrating element 30 reflects the outgoing light L1 emitted from the laser source 2. Accordingly, the frequency of the outgoing light L1 is shifted, and thus, the reference light L2 including the modulation component is generated. That is, the light modulator 12 modulates the frequency of the outgoing light L1.

As the vibrating element 30, there can be cited, for example, a crystal vibrator, a silicon vibrator, a ceramic vibrator, and a piezo element. Among them, the vibrating element 30 is preferably a crystal vibrator, a silicon vibrator, or a ceramic vibrator. Unlike other vibrators such as a piezo element, these vibrators are vibrators that utilize a mechanical resonance phenomenon, and is therefore high in Q-value, and it is possible to easily achieve stabilization of a natural frequency.

In addition, according to the light modulator 12 including the vibrating element 30, it is possible to dramatically reduce the volume and the weight as compared to modulators including, for example, an acousto-optics modulator (AOM) or an electro-optic modulator (EOM). Therefore, it is possible to achieve a reduction in size, weight, and power consumption of the laser interferometer 1. It should be noted that when a little decrease in these advantages is acceptable, the light modulator 12 can be replaced with a light modulator using the AOM or the EOM.

As the light modulator 12, there can be cited a light modulator disclosed in, for example, JP-A-2022-38156. In the publication, a quartz crystal AT vibrator is cited as the vibrator element. In addition, as the vibrating element 30, an SC-cut crystal vibrator, a tuning fork crystal vibrator, a quartz crystal surface acoustic wave element, or the like can be used.

A silicon vibrator is a vibrator including a single-crystal silicon piece manufactured from a single-crystal silicon substrate using an MEMS technique and a piezoelectric membrane. MEMS (Micro-Electro Mechanical Systems) means a micro-electromechanical system. As a shape of the single-crystal silicon piece, there can be cited a cantilever shape such as a two-leg tuning fork shape and a three-leg tuning fork shape, a fixed beam shape, and so on. An oscillation frequency of the silicon vibrator is, for example, about 1 kHz to several hundreds of MHz.

A ceramic vibrator is a vibrator including an electrode and a piezoelectric ceramic piece manufactured by sintering piezoelectric ceramics. As the piezoelectric ceramics, there can be cited, for example, lead zirconate titanate (PZT) and barium titanate (BTO). The oscillation frequency of the ceramic vibrator is, for example, about several hundreds of kHz to several tens of MHz.

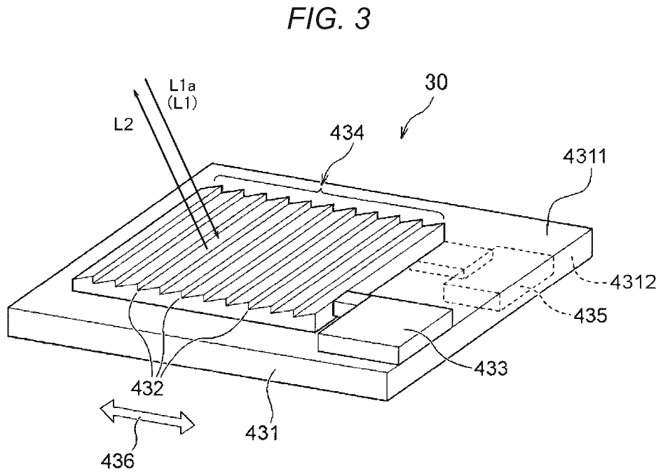

FIG. 3 is a perspective view showing a configuration example of the vibrating element 30 shown in FIG. 2.

The vibrating element 30 shown in FIG. 3 includes a vibrator element 431 shaped like a plate and a diffraction grating 434 provided to the vibrator element 431.

The vibrator element 431 is made of a material that repeats a mode in which the vibrator element 431 vibrates so as to be distorted in a direction along a surface when an electric potential is applied. The vibrator element 431 shown in FIG. 3 is a quartz crystal AT vibrator that makes a thickness shear vibration along a vibration direction 436 in a high-frequency range of a MHz band. Further, the diffraction grating 434 is disposed on a surface of the vibrator element 431. The diffraction grating 434 includes grooves 432 having a component crossing the vibration direction 436, that is, a plurality of grooves 432 each shaped like a straight line extending in a direction crossing the vibration direction 436.

The vibrator element 431 has an obverse surface 4311 and a reverse surface 4312 having an obverse-reverse relationship with each other. The diffraction grating 434 is disposed on the obverse surface 4311. In addition, the obverse surface 4311 is provided with a pad 433 for applying a potential to the vibrator element 431. Further, the reverse surface 4312 is also provided with a pad 435 for applying a potential to the vibrator element 431.

A size of the vibrator element 431 is, for example, about 0.50 mm or more and 10.0 mm or less in long side. Further, the thickness of the vibrator element 431 is, for example, about 0.10 mm or more and 2.0 mm or less. As an example, the shape of the vibrator element 431 is a square 1.6 mm on a side, and the thickness thereof is 0.35 mm.

The size of the diffraction grating 434 is, for example, about 0.20 mm or more and 3.0 mm or less in long side. Further, the thickness of the diffraction grating 434 is, for example, about 0.003 mm or more and 0.50 mm or less.

In the present embodiment, although the vibrator element 431 makes the thickness-shear vibration, the vibration is an in-plane vibration, as shown in FIG. 3 as the vibration direction 436, and therefore, even when light is made to perpendicularly enter the obverse surface of the vibrator element 431 as a simple body, the light modulation cannot be achieved. Therefore, in the vibrating element 30, the diffraction grating 434 is provided to the vibrator element 431 to thereby make the light modulation possible.

The diffraction grating 434 shown in FIG. 3 is, for example, a blazed diffraction grating. The blazed diffraction grating means a diffraction grating having a stepwise cross-sectional shape. It should be noted that the shape of the diffraction grating 434 is not limited thereto.

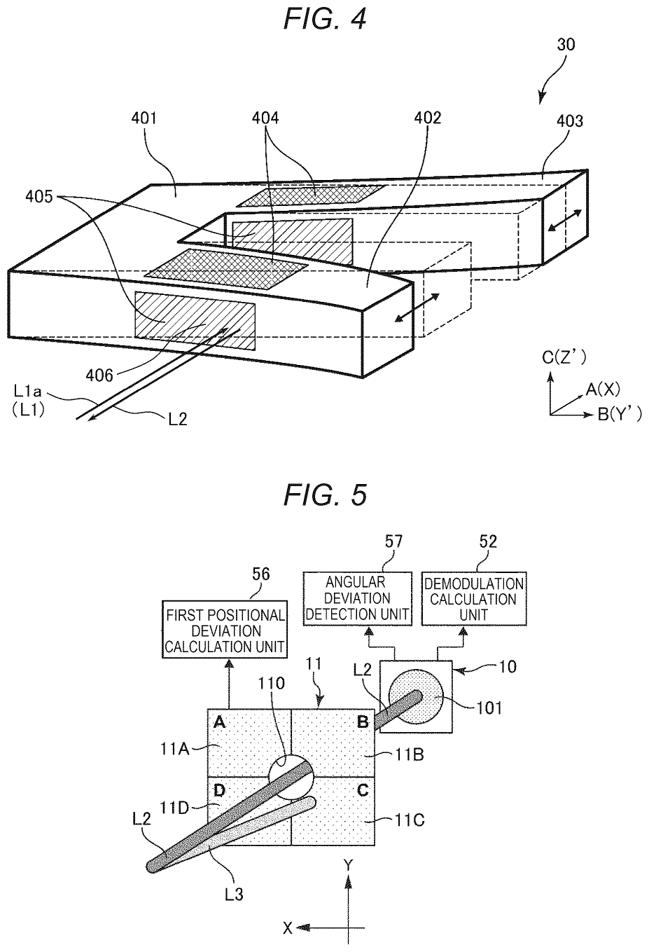

FIG. 4 is a perspective view showing another configuration example of the vibrating element 30 shown in FIG. 2. It should be noted that in FIG. 4, an A axis, a B axis, and a C axis are set as three axes perpendicular to each other, and are indicated by arrows. A tip side of the arrow is defined as a “positive side,” and a base end side of the arrow is defined as a “negative side.” Further, for example, both direction sides, the positive side and the negative side, of the A axis are referred to as an “A-axis direction.” The same applies to a B-axis direction and a C-axis direction.

The vibrating element 30 shown in FIG. 4 is a tuning fork crystal vibrator. The vibrating element 30 shown in FIG. 4 includes a vibrating substrate having a base unit 401, a first vibrating arm 402, and a second vibrating arm 403. Such a tuning fork crystal vibrator is easily available and achieves stable oscillation since the manufacturing technique thereof has been established. Therefore, the tuning fork crystal vibrator is suitable as the vibrating element 30. Further, the vibrating element 30 includes electrodes 404, 405 and a light reflecting surface 406 provided to the vibrating substrate.

The base unit 401 is a region extending along the A axis. The first vibrating arm 402 is a region extending from an end portion at a negative side of the A axis of the base unit 401 toward the positive side of the B axis. The second vibrating arm 403 is a region extending from an end portion at the positive side of the A axis of the base unit 401 toward the positive side of the B-axis.

The electrodes 404 are conductive films provided to side surfaces of the first vibrating arm 402 and the second vibrating arm 403 that are parallel to an A-B plane. Although not shown in FIG. 4, the electrodes 404 are provided respectively to the side surfaces opposed to each other, and drive the first vibrating arm 402 in response to voltages being applied thereto so as to be different in polarity from each other.

The electrodes 405 are conductive films provided to side surfaces of the first vibrating arm 402 and the second vibrating arm 403, the side surfaces crossing the A-B plane. It should be noted that although not shown in FIG. 4, the electrodes 405 are also provided respectively to the side surfaces opposed to each other, and drive the second vibrating arm 403 in response to voltages being applied thereto so as to be different in polarity from each other.

The light reflecting surface 406 is set on a side surface crossing the A-B plane out of the first vibrating arm 402 and the second vibrating arm 403, and has a function of reflecting the first split light L1a. The side surface refers to a surface extending along the extending direction of the first vibrating arm 402 and the second vibrating arm 403. The light reflecting surface 406 shown in FIG. 4 is set in particular on the surface of the electrode 405 out of the side surfaces of the first vibrating arm 402. The electrode 405 provided to the first vibrating arm 402 also has a function as the light reflecting surface 406. It should be noted that it is possible to arrange to provide a light reflecting film not shown separately from the electrode 405.

In the tuning fork crystal vibrator, a quartz crystal piece carved out from a quartz crystal substrate is used. As the quartz crystal substrate used for manufacturing the tuning fork crystal vibrator, there is cited, for example, a quartz crystal Z-cut flat plate. In FIG. 4, an X axis parallel to the A axis, a Y′ axis parallel to the B axis, and a Z′ axis parallel to the C axis are set. The quartz crystal Z-cut flat plate is, for example, a substrate carved out from a quartz single crystal such that the X axis is an electrical axis, the Y′ axis is a mechanical axis, and the Z′ axis is an optical axis. Specifically, in an orthogonal coordinate system formed of the X axis, the Y′ axis and the Z′ axis, a substrate having a principal surface which is obtained by tilting an X-Y′ plane defined by the X axis and the Y′ axis by about 1° to 5° in a counterclockwise direction around the X axis is carved out from the quartz single crystal and is preferably used as the quartz crystal substrate. Further, by etching such a quartz crystal substrate, the quartz crystal piece to be used for the vibrating element 30 shown in FIG. 4 is obtained. The etching can be either of wet etching and dry etching.

Alternatively, the light reflecting surface 406 can be set on the surface of the electrode 404. In this case, it is sufficient to adjust the signals to be applied to the respective electrodes so that the tuning fork crystal vibrator makes an out-of-plane vibration, for example, so as to excite spurious that makes the out-of-plane vibration.

### 1.1.8. First Aperture Element

The first aperture element 11 is disposed between the analyzer 9 and the light receiving element 10. The first aperture element 11 detects a positional deviation of the optical axis of the object light L3 from the optical axis of the reference light L2. It should be noted that in the present embodiment, the “positional deviation” refers to a state in which the positions of the optical axes described above are deviated from each other in a plane where the first aperture element 11 spreads.

FIG. 5 is a perspective view of the first aperture element 11 and the light receiving element 10 shown in FIG. 2 as viewed from the analyzer 9 side.

The first aperture element 11 shown in FIG. 5 is a quadrant photodiode having a first aperture 110 at the center. A light receiving surface of the quadrant photodiode is divided into four light detection areas, and each of the light detection areas has independent sensitivity. The first aperture element 11 has the light detection areas 11A, 11B, 11C, and 11D obtained by dividing the light receiving surface into a 2×2 matrix. Further, the first aperture 110 having a circular shape in the plan view is disposed at a position adjacent to the four light detection areas 11A, 11B, 11C, and 11D. The first aperture 110 penetrates the first aperture element 11 in the thickness direction.

As shown in FIG. 5, the first aperture element 11 is arranged such that the reference light L2 passes through the first aperture 110. Therefore, the reference light L2 is not detected by the first aperture element 11. In contrast, the position of the optical axis of the object light L3 changes according to the distance from the laser interferometer 1 to the object 14, the angle of the object 14, and so on. When the position of the optical axis of the object light L3 deviates from the optical axis of the reference light L2, the object light L3 fails to pass through the first aperture 110 and is detected by the first aperture element 11 as shown in FIG. 5.

The object light L3 with which the first aperture element 11 is irradiated is detected in any of the light detection areas 11A, 11B, 11C, and 11D, and a detection signal is output to the first positional deviation calculation unit 56. The first positional deviation calculation unit 56 calculates the position of the object light L3 based on an amount of light detected in each of the light detection areas. Based on the calculation result, the instruction unit 58 performs display of instructing a change of the arrangement on, for example, a display device not shown. It is possible for the user of the laser interferometer 1 to change the arrangement of either or both of the laser interferometer 1 and the object 14 based on the instruction to thereby adjust the optical axis of the object light L3. By changing the arrangement according to the instruction, it is possible to make the optical axis of the object light L3 come closer to the optical axis of the reference light L2. Accordingly, it is possible to correct the positional deviation between the optical axis of the reference light L2 and the optical axis of the object light L3.

The aperture size of the first aperture 110 is preferably about 90% or more and 150% or less of the beam diameter of the reference light L2, and more preferably about 95% or more and 110% or less thereof. Accordingly, the first aperture element 11 is capable of more reliably detecting the object light L3 having a positional deviation from the optical axis of the reference light L2.

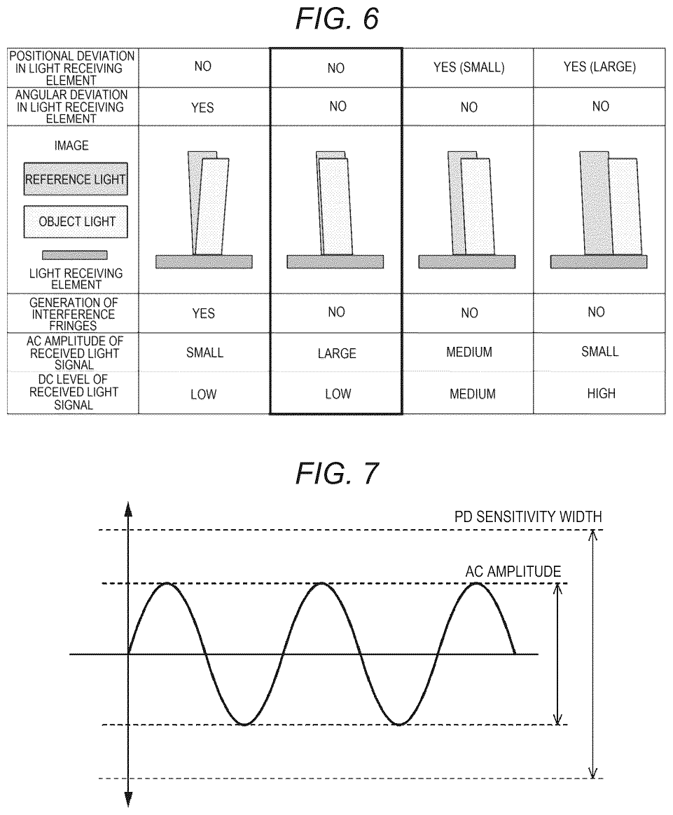

FIG. 6 is a table listing images of the positional deviation and the angular deviation between the reference light L2 and the object light L3 generated in the light receiving element 10 shown in FIG. 2, and influences thereof. FIG. 6 shows two examples for each of when there is no positional deviation and when there is a positional deviation. Further, even when there is no positional deviation, there is made a comparison between when there is an angular deviation and when there is no angular deviation. Further, even when there is a positional deviation, there is made a comparison between when the deviation is small and when the deviation is large. It should be noted that in the present embodiment, “angular deviation” refers to a state in which the optical axis of the reference light L2 and the optical axis of the object light L3 are nonparallel to each other in the light receiving element 10.

First, when there is no positional deviation and there is an angular deviation in the light receiving element 10, an interference fringe (bright and dark fringe) caused by the angular deviation is generated on the light receiving surface 101 of the light receiving element 10 shown in FIG. 5. When the interference fringe is generated, the amplitude (AC amplitude) of an AC component (an optical beat signal) of the received light signal becomes smaller as bright and dark cancel out each other. This incurs a decrease in S/N ratio of the optical beat signal. On the other hand, when there is neither the positional deviation nor the angular deviation in the light receiving element 10, no interference fringes are generated on the light receiving surface, and therefore, the AC amplitude of the received light signal becomes large. In addition, since there is no positional deviation, a region where any interference does not occur (non-interference region) does not occur, and the DC level of the received light signal becomes low.

On the other hand, when there is a positional deviation in the light receiving element 10 but there is no angular deviation, although the interference fringes are not generated, the AC amplitude and the DC level depend on the degree of the positional deviation. When the positional deviation is large, the overlapping region of the beams of the reference light L2 and the object light L3 is small, and the non-interference region is large, and therefore, the AC amplitude of the received light signal becomes small, and the DC level thereof becomes high. On the other hand, when the positional deviation is small, since the overlapping region of the beams is slightly larger and the non-interference region is slightly smaller, the AC region of the received light signal becomes slightly larger and the DC level becomes slightly lower.

In the laser interferometer and the method of adjusting the optical axis thereof according to the present embodiment, an instruction is issued to eliminate both the positional deviation and the angular deviation based on the relationship between the positional deviation or the angular deviation and the influence caused by the positional deviation or the angular deviation. That is, it is possible to help the user adjust the optical axis to achieve a reduction of the influence due to the optical axis deviation. Accordingly, it is possible to prevent a decrease in S/N ratio which is a problem inherent in the non-coaxial optical system, and realize the laser interferometer 1 high in measurement accuracy with respect to the object 14 while employing the non-coaxial optical system.

It should be noted that the number of divisions of the light detection area in the first aperture element 11 is not limited to four as long as it is plural. For example, the number of divisions can be eight or less or more. Further, the first aperture element 11 can be formed by arranging a plurality of non-divided photodiodes.

### 1.2. Signal Generation Unit

The signal generation unit 60 shown in FIG. 1 outputs the drive signal Sd, which is input to the vibrating element 30, and a reference signal Ss which is input to the demodulation calculation unit 52.

In the present embodiment, as shown in FIG. 1, the signal generation unit 60 includes an oscillation circuit 61. The oscillation circuit 61 operates using the vibrating element 30 as a signal source, and generates a highly accurate periodic signal. Accordingly, the oscillation circuit 61 outputs the drive signal Sd with high accuracy, and outputs the reference signal Ss. Therefore, the drive signal Sd and the reference signal Ss are affected in the same way when being subjected to a disturbance. As a result, the modulation component added via the vibrating element 30 driven by the drive signal Sd and the reference signal Ss are also affected in the same way. Therefore, when the modulation component and the reference signal Ss are subjected to the calculation in the demodulation calculation unit 52, the influence of the disturbance included in both of the modulation component and the reference signal Ss can be canceled out or reduced in the process of the calculation. As a result, the demodulation calculation unit 52 can accurately obtain the position and the velocity of the object 14 even when subjected to disturbance. In addition, it is possible to achieve the reduction in size, weight, and power consumption of the laser interferometer 1.

As the oscillation circuit 61, there can be cited, for example, an oscillation circuit disclosed in JP-A-2022-38156.

Further, the signal generation unit 60 can include a signal generator such as a function generator or a so-called signal generator instead of the oscillation circuit 61.

### 1.3. Demodulation Calculation Unit

The demodulation calculation unit 52 provided to the main body unit 59 shown in FIG. 1 includes a preprocessing unit 53, a demodulation processing unit 54, and a demodulated signal output unit 55. Functions realized by these functional units are implemented by hardware including, for example, a processor, a memory, an external interface, an input unit, and a display unit. Specifically, the functions are implemented by the processor reading and executing a program stored in the memory. It should be noted that these constituents are made capable of communicating with each other via an external bus.

As the processor, there can be cited, for example, a central processing unit (CPU) and a digital signal processor (DSP). It should be noted that it is possible to arrange to adopt a system in which a field-programmable gate array (FPGA), an application-specific integrated circuit (ASIC), or the like realizes the functions described above instead of the system in which these processors execute software.

As the memory, there can be cited, for example, a hard disk drive (HDD), a solid state drive (SSD), an electrically erasable programmable read-only memory (EEPROM), a read-only memory (ROM), and a random access memory (RAM).

As the external interface, there can be cited, for example, a digital input and output port such as a universal serial bus (USB), an Ethernet® port, a wireless local area network (LAN), and Bluetooth®.

As the input unit, there can be cited various input devices such as a keyboard, a mouse, a touch panel, and a touch pad. As the display unit, there can be cited, for example, a liquid crystal display panel and an organic electro luminescence (EL) display panel.

It should be noted that the external interface, the input unit, and the display unit are only required to be disposed as needed, and can be omitted.

To the preprocessing unit 53 and the demodulation processing unit 54, there can be applied, for example, a preprocessing unit and a demodulation unit disclosed in JP-A-2022-38156.

The preprocessing unit 53 performs the preprocessing on the received light signal based on the reference signal Ss. In the preprocessing, a received light signal is divided into two signals, then one of the two signals is multiplied by the reference signal, and then the two signals are combined with each other to output a preprocessed signal.

The demodulation processing unit 54 demodulates the sample-derived component corresponding to the velocity and position of the object 14 from the preprocessed signal output from the preprocessing unit 53 based on the reference signal Ss.

The demodulated signal output unit 55 can calculate the position of the object 14 from the sample-derived component, specifically, the phase information derived from the object 14 included in the pre-processed signal, and in this case, the laser interferometer 1 can be used as a displacement gauge. Further, it is possible to obtain speed from the position of the object 14, and in this case, the laser interferometer 1 is used as a speed meter.

### 1.4. First Positional Deviation Calculation Unit

The first positional deviation calculation unit 56 provided to the main body unit 59 shown in FIG. 1 calculates the irradiation position with the object light L3 based on the detection signal output from the first aperture element 11. The irradiation position with the object light L3 can be calculated in such a manner as follows.

First, when amounts of light detected by the light detection areas 11A, 11B, 11C, and 11D are denoted by PA, PB, PC, and PD, respectively, the total amount of the light detected by the first aperture element 11 is PA+PB+PC+PD.

Here, a normalized coordinate system (X, Y) is considered in an orthogonal coordinate system which is represented by the X axis and the Y axis shown in FIG. 5, and the origin of which is set to the center of the first aperture element 11. In FIG. 5, the X axis is represented by an arrow, wherein the tip side of the arrow is defined as a positive side, and the base end side thereof is defined as a negative side. The same applies to the Y axis. In this case, the normalized coordinates (X, Y) of the irradiation position with the object light L3 are expressed by Formula (1) described below.

$$\\ \begin{matrix}Formula 1 & \\ ( X , Y ) = ( \frac{( PA + PD ) - ( PB + PC )}{PA + PB + PC + PD} , \frac{( PA + PB ) - ( PC + PD )}{PA + PB + PC + PD} ) & ( 1 )\end{matrix}$$

The origin of the normalized coordinate system (X, Y) is located at the center of the first aperture 110 surrounded by the light detection areas 11A, 11B, 11C, and 11D. Therefore, the current position of the object light L3 (the light detection area reached by the object light L3) can be estimated from the signs of the normalized coordinates obtained from the detection signal in the light of Table 1 described below.

TABLE 1

| Sign of X coordinate | Sign of Y-coordinate | Light Detection Area |
|---|---|---|
| + | + | A |
| + | − | D |
| − | + | B |
| − | − | C |

The first positional deviation calculation unit 56 estimates the current position of the object light L3 by performing such a calculation as described above. Accordingly, the direction in which the optical axis of the object light L3 deviates from the optical axis of the reference light L2 passing through the first aperture 110 can be obtained. It should be noted that the method of calculating the current position of the object light L3 is not limited to the method described above. For example, when an element other than the divided photodiode is used as the first aperture element 11, a calculation method different from the above can be used.

### 1.5. Angular Deviation Detection Unit

The angular deviation detection unit 57 provided to the main body unit 59 shown in FIG. 1 detects the angular deviation of the optical axis of the object light L3 from the optical axis of the reference light L2 based on the received light signal output from the light receiving element 10.

When such an angular deviation occurs, an occurrence of the interference fringe is observed in the light receiving element 10 as shown in FIG. 6 even when the positional deviation does not occur. Therefore, the angular deviation detection unit 57 detects the angular deviation based on the received light signal.

When interference fringe occurs, as the described above, the AC amplitude of the received light signal decreases despite the reference light L2 and the object light L3 interfere with each other. Therefore, the angular deviation detection unit 57 detects the angular deviation based on the AC amplitude of the received light signal.

FIG. 7 is a waveform showing an example of the AC component of the received light signal. It should be noted that FIG. 7 also shows a sensitivity width (PD sensitivity width) of the light receiving element 10.

As shown in FIG. 7, the AC component of the received light signal is a periodic signal that vibrates at a predetermined period. Therefore, the angular deviation detection unit 57 detects the amplitude (AC amplitude) of the AC component of the received light signal. Then, whether the AC amplitude is equal to or greater than a threshold value is determined. When the AC amplitude is equal to or greater than the threshold value, it can be assumed that the angular deviation does not occur. On the other hand, when the AC amplitude is less than the threshold value, it can be assumed that the angular deviation has occurred. In such a manner as described above, it is possible to detect whether the angular deviation has occurred. Since the AC amplitude affects the S/N ratio (signal-to-noise ratio) of the sample-derived component demodulated from the light receiving signal, the measurement accuracy of the object 14 can be improved by ensuring a large AC amplitude.

### 1.6. Instruction Unit

The instruction unit 58 provided to the main body unit 59 shown in FIG. 1 issues an instruction to change the arrangement based on the calculation result (detection result of the positional deviation in the first aperture element 11) by the first positional deviation calculation unit 56 and the detection result (detection result of the angular deviation) by the angular deviation detection unit 57. The arrangement means a relative arrangement of the laser interferometer 1 (the interference optical system 50) and the object 14. Specifically, the relative arrangement of the laser interferometer 1 and the object 14 is changed by changing the distance between the laser interferometer 1 and the object 14 or changing the posture of the laser interferometer 1 or the object 14.

As the content of the instruction by the instruction unit 58, there can be cited, for example, a display representing the current value of the positional deviation or the angular deviation, and a display for inducing correction of the positional deviation or the angular deviation. As the method of the instruction, there can be cited, for example, a method of displaying characters, figures, and the like on the display unit described above, a method of changing the color or a blinking pattern of light, or a level or a height of sound in accordance with the content of the instruction, and a method of reading out the content of the instruction. The content of the instruction can also be, for example, what indicates a relative displacement direction of the laser interferometer 1 (the interference optical system 50) with respect to the object 14. By following such an instruction, the user can easily change the arrangement to efficiently adjust the optical axis.

### 2. Method of Adjusting Optical Axis of Laser Interferometer

Then, a method of adjusting the optical axis of the laser interferometer according to the embodiment will be described. It should be noted that in the following description, a method of adjusting the optical axis of the laser interferometer 1 described above will be described as an example.

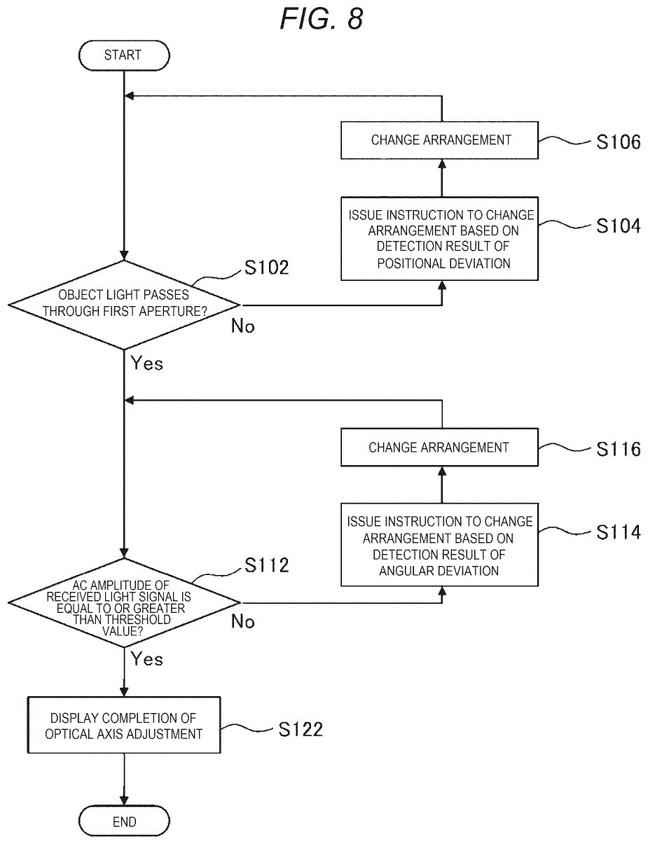

FIG. 8 is a flowchart representing a configuration of the method of adjusting the optical axis of the laser interferometer according to the embodiment.

In step S102 shown in FIG. 8, the instruction unit 58 determines whether the object light L3 has passed through the first aperture 110 based on the calculation result of the first positional deviation calculation unit 56. It should be noted that in the laser interferometer 1, as described above, the optical axis is adjusted in advance so that the reference light L2 passes through the first aperture 110. Therefore, it is preferable that all the light detected by the first aperture element 11 is the object light L3, but it is acceptable that a part of the reference light L2 is detected by the first aperture element 11 if it is small in amount. When the amount of the light detected by the first aperture element 11 is zero, the instruction unit 58 determines that the whole beam of the object light L3 passes through the first aperture 110. In this case, the determination result in step S102 is Yes, and the process proceeds to step S112. On the other hand, when the amount of the light detected by the first aperture element 11 exceeds zero, the instruction unit 58 determines that at least a part of the beam of the object light L3 has failed to pass through the first aperture 110. In this case, the determination result in step S102 is No, and the process proceeds to step S104. It should be noted that the “zero” described above may have a predetermined allowable range. That is, the “zero” described above is a concept having a minute width that can be regarded as zero in addition to a strict zero state. The same applies to other “zeros” described later.

In step S104, the instruction unit 58 issues an instruction to change the arrangement based on the calculation result of the first positional deviation calculation unit 56. Here, as an example of the instruction, an instruction to induce the change of the arrangement so that the optical axis of the object light L3 moves in the direction in which the positional deviation is eliminated will be described.

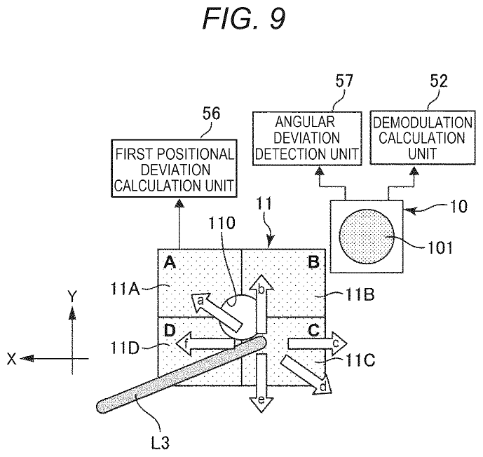

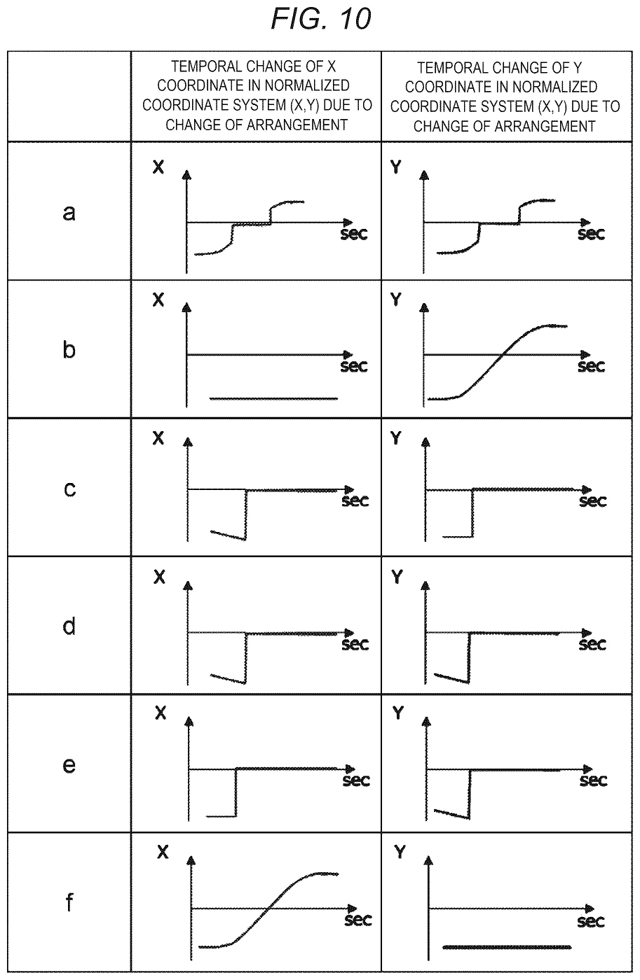

FIG. 9 is a perspective view schematically showing an example in which the irradiation position with the object light L3 shown in FIG. 5 moves in six directions, namely directions a through f. Further, FIG. 10 is a graph showing temporal changes of the X coordinate and the Y coordinate in the normalized coordinate system (X, Y) when the irradiation position with the object light L3 moves in the six directions, the directions a through f shown in FIG. 9.

Before the arrangement is changed, the irradiation position with the object light L3 shown in FIG. 9 is in the light detection area 11C. That is, the X coordinate and the Y coordinate in the normalized coordinate system (X, Y) are each a negative value. Subsequently, when the arrangement is changed so that the irradiation position with the object light L3 moves in, for example, the direction a, the X coordinate gradually increases after starting the change of the arrangement as shown in the uppermost graph of FIG. 10, and then becomes substantially zero at the timing when the object light L3 reaches the first aperture 110. Then, at a timing when the object light L3 passes through the first aperture 110, the X coordinate turns to a positive value. Meanwhile, as shown in the uppermost graph of FIG. 10, the Y coordinate also gradually increases after starting the change of the arrangement, and then becomes substantially zero at the timing when the object light L3 reaches the first aperture 110. Then, at a timing when the object light L3 passes through the first aperture 110, the X coordinate turns to a positive value.

The first positional deviation calculation unit 56 holds such temporal changes of the X coordinate and the Y coordinate as described above in advance as patterns. Then, when the optical axis adjustment is performed, it is possible to detect that the irradiation position with the object light L3 has moved from the light detection area 11C in the direction a by acquiring such changes in the X coordinate and the Y coordinate as shown in FIG. 10 and then comparing the changes with the pattern held by the first positional deviation calculation unit 56. In this case, the instruction unit 58 notifies the user of the fact that the movement in the direction a has occurred via the display unit or the like. As a result, the user can easily associate the change content of the arrangement with the movement direction of the irradiation position with the object light L3. That is, the user can easily understand that the irradiation position with the object light L3 has moved from the light detection area 11C to the light detection area 11A via the first aperture 110. As a result, the user can easily find out the change content of the arrangement of moving the irradiation position with the object light L3 from the light detection area 11A to the first aperture 110. Although an example of the content of the instruction is hereinabove described, the content of the instruction is not limited to the above.

In step S106, the user changes the arrangement in accordance with the instruction. Accordingly, the optical axis of the object light L3 can easily be aligned with the first aperture 110. As a result, the positional deviation of the optical axis of the object light L3 with respect to the optical axis of the reference light L2 can be eliminated. Subsequently, the process returns to step S102.

On the other hand, as described above, when the determination result in step S102 is Yes, the process proceeds to step S112. In step S112, whether the AC amplitude of the received light signal is equal to or greater than the threshold value is determined. When the AC amplitude is equal to or greater than the threshold value, it can be assumed that the angular deviation does not occur. In this case, since the determination result in step S112 is Yes, the process proceeds to step S122. In step S122, the instruction unit 58 makes, for example, the display unit display the completion of the optical axis adjustment. Accordingly, it is possible for the user to terminate the optical axis adjustment. On the other hand, when the AC amplitude is less than the threshold value, it can be assumed that the angular deviation has occurred. In this case, since the determination result in step S112 is No, the process proceeds to step S114.

In step S114, the instruction unit 58 issues an instruction to change the arrangement based on the detection result of the angular deviation. As an example of the instruction, there can be cited an instruction to quantitatively display the AC amplitude in real time. It is possible for the user to perform an operation of changing the arrangement while monitoring the display of a numerical value or the like that changes in real time. In this case, since it is sufficient to change the arrangement in a direction of increasing the numerical value or the like, it is possible to efficiently perform the operation.

Here, two examples different in arrangement from each other will be described.

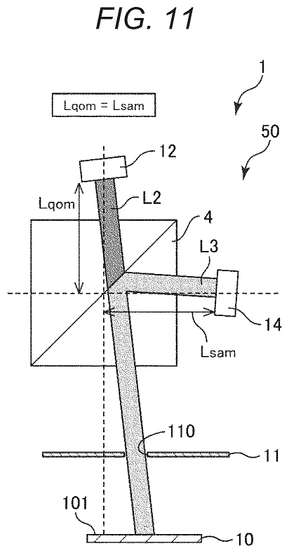

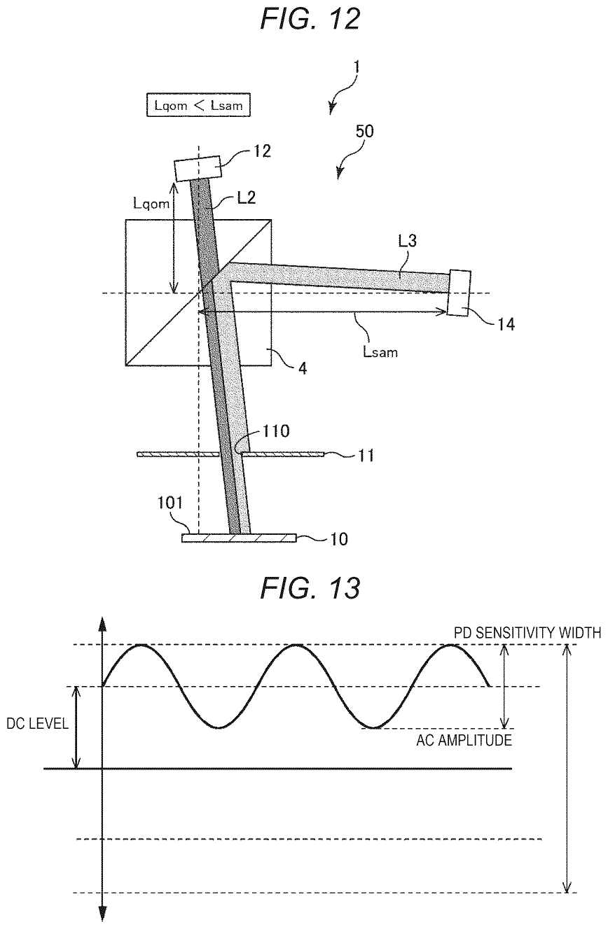

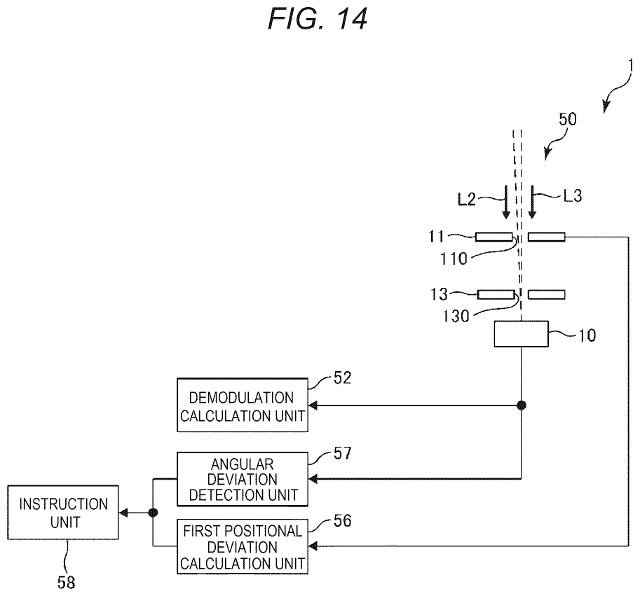

FIG. 11 is a diagram schematically showing an arrangement example when the AC amplitude in FIG. 7 is maximized. Further, FIG. 12 is a diagram schematically showing an arrangement example when the AC amplitude becomes smaller than that in the arrangement example shown in FIG. 11. Further, FIG. 13 is a waveform showing an example of the AC amplitude and the DC level of the received light signal which is observed in the arrangement example in FIG. 12.

The arrangement example shown in FIG. 11 corresponds to the arrangement example surrounded by a thick line in FIG. 6. In this arrangement example, when an optical distance between the light splitter 4 and the light modulator 12 is denoted by Lqom and the optical distance between the light splitter 4 and the object 14 is denoted by Lsam, Lqom=Lsam is true. Since this equation is true, both the positional deviation and the angular deviation can be eliminated. Accordingly, the AC amplitude can be maximized, and the DC level can be minimized. As long as the DC level can be minimized, it becomes hard for the AC amplitude to exceed the sensitivity width of the light receiving element 10 even when the AC amplitude increases. The arrangement example shown in FIG. 12 corresponds to an arrangement example in which the positional deviation has occurred but the angular deviation does not occur in FIG. 6. In this arrangement example, the optical distance Lsam is longer than that in FIG. 11 while keeping the state in which it is assumed that there is no angular deviation. Therefore, although no interference fringe is generated, the AC amplitude of the received light signal observed becomes smaller than the AC amplitude shown in FIG. 7 as shown in FIG. 13. Further, since a non-interference region is generated on the light receiving surface 101 of the light receiving element 10, the DC level of the received light signal increases. When the DC level increases in such a manner, there is a possibility that the AC amplitude exceeds the PD sensitivity width shown in FIG. 13.

In contrast, in the present embodiment, it is possible to cut a part of the beam of the object light L3 which is the non-interference region with the first aperture element 11 as shown in FIG. 12. Therefore, in the present embodiment, even when the non-interference region is generated on the light receiving surface 101, an increase in the DC level of the received light signal can be prevented.

Based on the arrangement examples of FIG. 11 and FIG. 12, the optical distance between an exit port of the second split light L1b emitted from the laser interferometer 1 toward the object 14 and the light splitter 4 is preferably designed to be equal to the optical distance Lqom described above. By adopting this design, the optical distance Lsam inevitably becomes longer than the optical distance Lqom. As a result, it is possible to appreciate the advantage described above, that is, the advantage that the increase in the DC level of the received light signal can be prevented.

In step S116, the user changes the arrangement while monitoring the display indicating the AC amplitude. Accordingly, it is possible to change the arrangement in a direction of reducing the angular deviation. It should be noted that, in principle, the adjustment is performed so as to maximize the AC amplitude, but in the process of this adjustment, there can occur a situation in which the first aperture element 11 is irradiated with the light and an acceptance criterion in step S102 described above is not satisfied. In that case, the process may return to step S102, but: it is preferable to perform processing of returning to step S112 as shown in FIG. 8 in order to change the arrangement giving priority to the reduction of the angular deviation.

### 3. First Modified Example

Then, a laser interferometer and a method of adjusting the optical axis thereof according to a first modified example of the embodiment described above will be described.

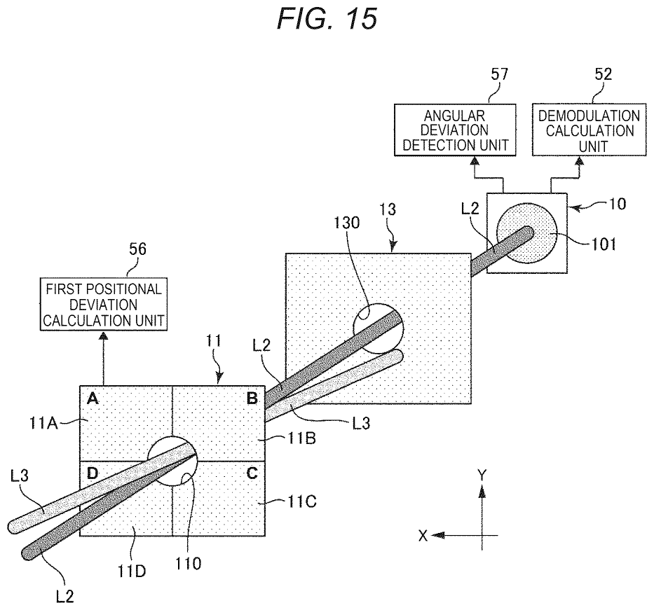

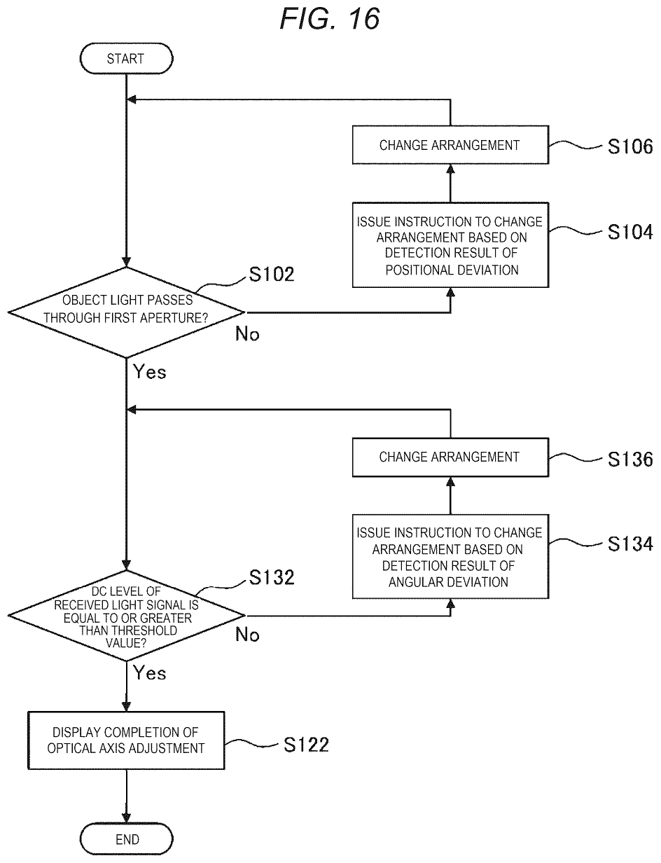

FIG. 14 is a schematic configuration diagram showing a part of the interference optical system 50 provided to the laser interferometer 1 according to the first modified example. FIG. 15 is a perspective view showing the first aperture element 11, an aperture 13, and the light receiving element 10 shown in FIG. 14. FIG. 16 is a flowchart representing a configuration of the method of adjusting the optical axis of the laser interferometer according to the first modified example.

The first modified example will hereinafter be described, and in the following description, differences from the embodiment described above will mainly be described, and a description of substantially the same matters will be omitted. It should be noted that in the drawings of the present modified example, substantially the same constituents as those of the embodiment are denoted by the same reference symbols.

The laser interferometer 1 according to the first modified example is the same as the laser interferometer 1 according to the embodiment described above except that the aperture 13 disposed between the first aperture element 11 and the light receiving element 10 is provided.

The aperture 13 is an optical element having a through hole 130. As shown in FIG. 14, the aperture 13 is arranged so that the reference light L2 having passed through the first aperture 110 of the first aperture element 11 passes through the through hole 130. Therefore, when the optical axis of the object light L3 is nonparallel to the optical axis of the reference light L2, that is, when the angular deviation has occurred between the optical axes of the object light L3 and the reference light L2, even when the object light L3 passes through the first aperture 110, the object light L3 fails to pass through the through hole 130 and is blocked by the aperture 13 as shown in FIG. 15. Therefore, the object light L3 in which the angular deviation has occurred fails to reach the light receiving element 10.

In contrast, the object light L3 in which no angular deviation occurs can pass through both the first aperture 110 and the through hole 130 to reach the light receiving element 10. That is, in the first modified example, only the object light L3 in which no angular deviation has occurred can reach the light receiving element 10. Therefore, in the first modified example, it becomes possible to detect the angular deviation based on the DC level of the received light signal instead of detecting the angular deviation based on the AC amplitude of the received light signal. Therefore, it is possible for the user to grasp the presence or absence and the degree of the angular deviation more intuitively and accurately than the embodiment described above.

The aperture size of the through hole 130 is preferably about 90% or more and 150% or less of the beam diameter of the reference light L2, and is more preferably about 95% or more and 110% or less thereof. Accordingly, the aperture 13 can more reliably block the object light L3 having the angular deviation from the optical axis of the reference light L2. Further, the aperture size of the through hole 130 is preferably equal to the aperture size of the first aperture 110. The term “equal” means to fall within a range of 100%+5% of the aperture size of the first aperture 110.

Further, the method of adjusting the optical axis of the laser interferometer according to the first modified example is substantially the same as the method of adjusting the optical axis of the laser interferometer according to the embodiment described above except that steps S112, S114, and S116 are replaced with steps S132, S134, and S136.

Steps S102, S104, and S106 shown in FIG. 16 are substantially the same as those in FIG. 8. When the determination result in step S102 shown in FIG. 16 is Yes, the process proceeds to step S132.

In step S132 shown in FIG. 16, whether the DC level of the received light signal is equal to or higher than the threshold value is determined. The DC level is a DC offset of the received light signal which is a periodic signal. When the DC level is equal to or higher than the threshold value, it can be assumed that the angular deviation does not occur. In this case, since the determination result of step S132 is Yes, the process proceeds to step S122. On the other hand, when the DC level is lower than the threshold value, it can be assumed that the angular deviation has occurred. In this case, since the determination result in step S132 is No, the process proceeds to step S134.

In step S134, the instruction unit 58 issues the instruction to change the arrangement based on the detection result of the angular deviation. As an example of the instruction, there can be cited an instruction to quantitatively display the DC level in real time. It is possible for the user to perform an operation of changing the arrangement while monitoring the display of a numerical value or the like that changes in real time. In this case, since it is sufficient to change the arrangement in a direction of increasing the numerical value or the like, it is possible to efficiently perform the operation. In particular, the DC level is often interlocked with a change in arrangement. Therefore, the user can intuitively change the arrangement and can efficiently adjust the optical axis.

In step S136, the user changes the arrangement while monitoring the display indicating the DC level. Accordingly, it is possible to efficiently change the arrangement in a direction of reducing the angular deviation. It should be noted that, in principle, adjustment is performed so as to maximize the DC level, but in the process of this adjustment, there can occur a situation in which the first aperture element 11 is irradiated with light and the acceptance criterion in step S102 described above is not satisfied. In that case, the process can return to step S102, but it is preferable to perform processing of returning to step S132 as shown in FIG. 16 in order to change the arrangement giving priority to the reduction of the angular deviation.

Step S122 shown in FIG. 16 is substantially the same as that in FIG. 8.

In such a first modified example as described above, substantially the same advantages as those of the embodiment described above can be obtained.

### 4. Second Modified Example

Then, a laser interferometer and a method of adjusting the optical axis thereof according to a second modified example of the embodiment described above will be described.

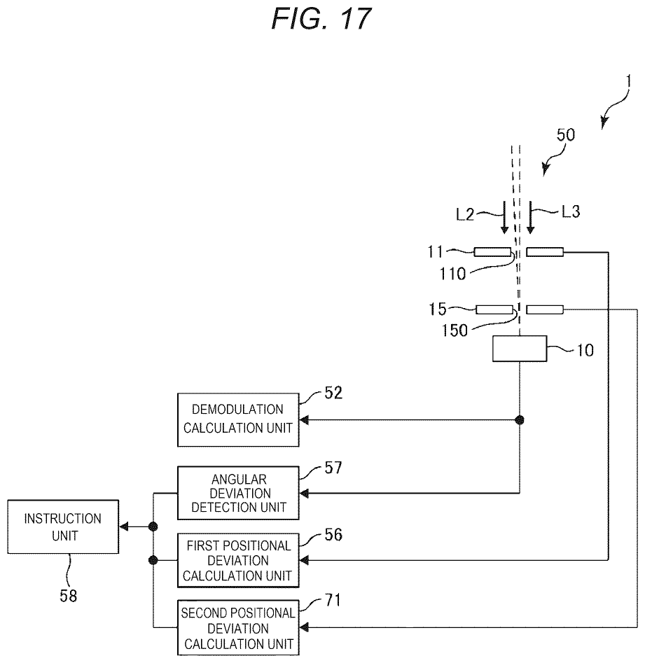

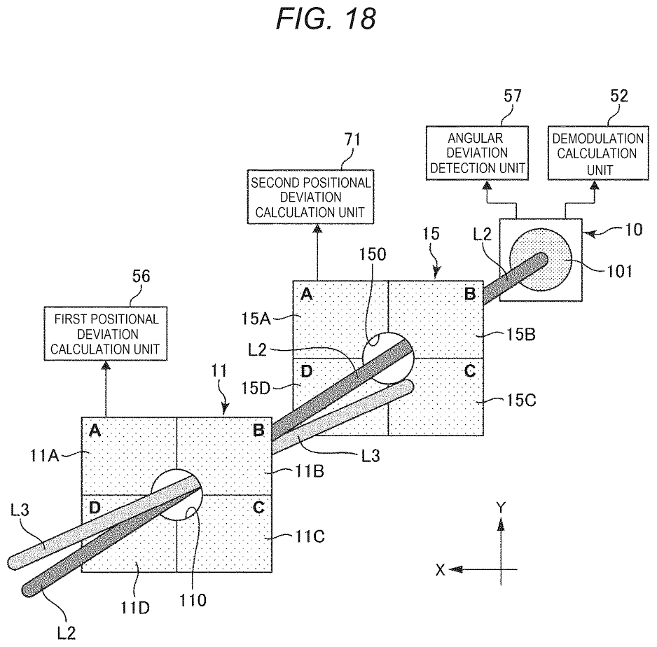

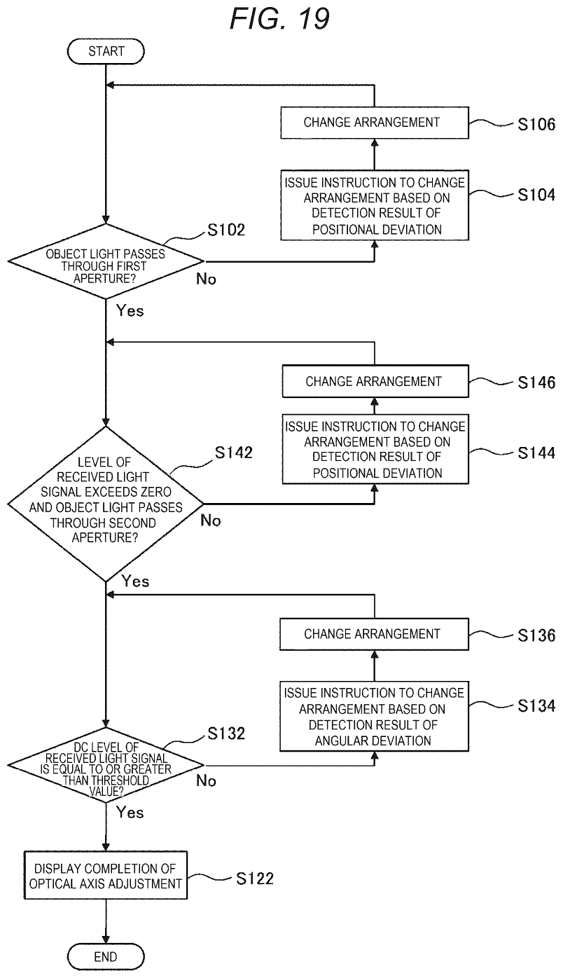

FIG. 17 is a schematic configuration diagram showing a part of the interference optical system 50 provided to the laser interferometer 1 according to the second modified example. FIG. 18 is a perspective view showing the first aperture element 11, a second aperture element 15, and the light receiving element 10 shown in FIG. 17. FIG. 19 is a flowchart representing a configuration of the method of adjusting the optical axis of the laser interferometer according to the second modified example.

The second modified example will hereinafter be described, and in the following description, differences from the embodiment described above or the modified example described above will mainly be described, and a description of substantially the same matters will be omitted. It should be noted that in the drawings of the present modified example, substantially the same constituents as those of the embodiment described above or the modified example described above are denoted by the same reference symbols.

The laser interferometer 1 according to the second modified example is the same as the laser interferometer 1 according to the embodiment described above except that the second aperture element 15 disposed between the first aperture element 11 and the light receiving element 10 is provided.

The second aperture element 15 shown in FIG. 18 is a quadrant photodiode having a second aperture 150 at the center similarly to the first aperture element 11. A light receiving surface of the quadrant photodiode is divided into four light detection areas, and each of the light detection areas has independent sensitivity. The second aperture element 15 has the light detection areas 15A, 15B, 15C, and 15D obtained by dividing the light receiving surface into a 2×2 matrix. Further, the second aperture 150 having a circular shape in the plan view is disposed at a position adjacent to the four light detection areas 15A, 15B, 15C, and 15D. The second aperture 150 penetrates the second aperture element 15 in the thickness direction.

As shown in FIG. 18, the second aperture element 15 is arranged so that the reference light L2 having passed through the first aperture 110 of the first aperture element 11 passes through the second aperture 150. Therefore, when the optical axis of the object light L3 is nonparallel to the optical axis of the reference light L2, that is, when the angular deviation has occurred between the optical axes of the object light L3 and the reference light L2, even when the object light L3 passes through the first aperture 110, the object light L3 fails to pass through the second aperture 150 and is irradiated with either one of the light detection areas 15A, 15B, 15C, and 15D as shown in FIG. 18. Therefore, the object light L3 in which the angular deviation has occurred fails to reach the light receiving element 10.

In contrast, the object light L3 in which no angular deviation occurs can pass through both the first aperture 110 and the second aperture 150 to reach the light receiving element 10. That is, in the second modified example, only the object light L3 in which no angular deviation has occurred can reach the light receiving element 10. Therefore, in the second modified example, the angular deviation can be detected based on the DC level of the received light signal instead of detecting the angular deviation based on the AC amplitude of the received light signal. Therefore, it is possible for the user to grasp the presence or absence and the degree of the angular deviation more intuitively and accurately than the embodiment described above.

The aperture size of the second aperture 150 is preferably about 90% or more and 150% or less of the beam diameter of the reference light L2, and more preferably about 95% or more and 110% or less thereof. Accordingly, the second aperture element 15 can more reliably block the object light L3 having the angular deviation from the optical axis of the reference light L2. Further, the aperture size of the second aperture 150 is preferably equal to the aperture size of the first aperture 110. The term “equal” means to fall within a range of 100%+5% of the aperture size of the first aperture 110.

In addition, in the laser interferometer 1 shown in FIG. 17, there is added a second positional deviation calculation unit 71. The second positional deviation calculation unit 71 calculates the position of the object light L3 based on the detection signal output from the second aperture element 15. The method of calculating the position of the object light L3 is the same as that of the first positional deviation calculation unit 56. The current position of the object light L3 can be estimated by calculating the position of the object light L3. Thus, it is possible to obtain the direction in which the optical axis of the object light L3 is displaced from the optical axis of the reference light L2 passing through the second aperture 150. It should be noted that in the present modified example, the “positional deviation” refers to a state in which the positions of the optical axes described above are deviated from each other in a plane where the first aperture element 11 spreads or a plane where the second aperture element 15 spreads. It should be noted that the method of calculating the current position of the object light L3 is not limited thereto. For example, when an element other than the divided photodiode is used as the second aperture element 15, a calculation method different from the above can be used.

The instruction unit 58 shown in FIG. 17 issues an instruction to change the arrangement based on the calculation result (detection result of the positional deviation) by the first positional deviation calculation unit 56, the calculation result (detection result of the positional deviation) by the second positional deviation calculation unit 71, and the detection result (detection result of the angular deviation) by the angular deviation detection unit 57. It should be noted that although the calculation result by the second positional deviation calculation unit 71 includes the direction of the positional deviation in the second aperture element 15, only the object light L3 in which no positional deviation occurs reaches the second aperture element 15. Therefore, it can be said that the direction of the positional deviation in the second aperture element 15 represents the direction of the angular deviation as a result. Accordingly, the angular deviation can efficiently be corrected by changing the arrangement in accordance with the instruction issued by the instruction unit 58 shown in FIG. 17.

Further, the method of adjusting the optical axis of the laser interferometer according to the second modified example is substantially the same as the method of adjusting the optical axis of the laser interferometer according to the first modified example except that steps S112, S114, and S116 are replaced with steps S132, S134, and S136, and steps S142, S144, and S146 are added.

Steps S102, S104, and S106 shown in FIG. 19 are substantially the same as those in FIG. 8. When the determination result in step S102 shown in FIG. 19 is Yes, the process proceeds to step S142.

In step S142, the instruction unit 58 determines whether the level of the received light signal exceeds zero and the object light L3 has passed through the second aperture 150 based on the level of the received light signal and the calculation result by the second positional deviation calculation unit 71. In the laser interferometer 1, as described above, the optical axis is adjusted in advance so that the reference light L2 passes through the second aperture 150. Accordingly, the level of the received light signal exceeds zero in principle. The level of the received light signal exceeding zero means a state in which the light receiving element 10 receives some light and the received light signal has an amplitude. Further, in principle, all the light detected by the second aperture element 15 is the object light L3. When the amount of light detected by the second aperture element 15 is zero, the instruction unit 58 determines that the whole beam of the object light L3 passes through the second aperture 150. In this case, the determination result in step S142 is Yes, and the process proceeds to step S132. On the other hand, when the amount of the light detected by the second aperture element 15 exceeds zero, the instruction unit 58 determines that at least a part of the beam of the object light L3 has failed to pass through the second aperture 150. In this case, the determination result in step S142 is No, and the process proceeds to step S144.

Here, three examples different in state of the positional deviation and the angular deviation in the first aperture element 11 from each other will be described.

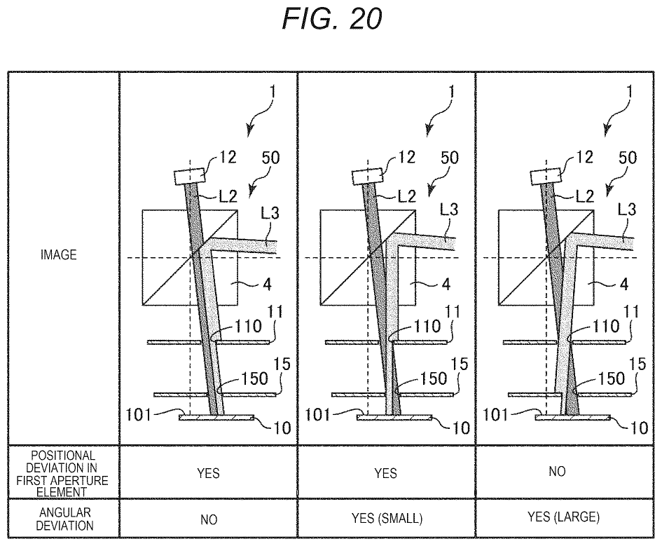

FIG. 20 is a schematic configuration diagram showing the interference optical system 50 provided to the laser interferometer 1 according to the second modified example shown in FIG. 17, and is a diagram in which three examples different in light trace of the object light L3 from each other are compared with each other.

A left diagram of FIG. 20 schematically shows when there is a positional deviation in the first aperture element 11 and there is no angular deviation. In this case, since the level of the received light signal exceeds zero and the amount of light detected by the second aperture element 15 is zero, the determination result in step S142 is Yes.

A center diagram of FIG. 20 schematically shows when there is a positional deviation in the first aperture element 11, and there is also an angular deviation. It should be noted that although there is the angular deviation, the whole beam of the object light L3 passes through the second aperture 150. In this case, since the level of the received light signal exceeds zero and the amount of light detected by the second aperture element 15 is zero, the determination result in step S142 is Yes.

A right diagram of FIG. 20 schematically shows when there is no positional deviation in the first aperture element 11 but there is an angular deviation. Further, a part of the beam of the object light L3 deviates from the second aperture 150. In this case, the level of the received light signal exceeds zero, and the amount of light detected by the second aperture element 15 exceeds zero. Accordingly, the determination result in step S142 is No.

Incidentally, when the center diagram and the right diagram in FIG. 20 are compared to each other, the degree of angular deviation is different. Specifically, the right diagram is larger in angular deviation than the center diagram. In the determination in step S142, it is possible to detect the state of the right diagram. This makes it possible to correct the angular deviation in the state of the right diagram.

In step S144, the instruction unit 58 issues an instruction to change the arrangement based on the level of the received light signal and the calculation result by the second positional deviation calculation unit 71. The content of the instruction is the same as the content of inducing the change of the arrangement in the direction of eliminating the positional deviation in step S104 in the embodiment described above.

In step S146, the user changes the arrangement in accordance with the instruction. Accordingly, it is possible to efficiently change the arrangement in a direction of reducing the angular deviation. Subsequently, the process returns to step S142.

Steps S132, S134, and S136 shown in FIG. 19 are substantially the same as those in FIG. 16. Further, step S122 shown in FIG. 19 is substantially the same as that in FIG. 8.

In such a second modified example as described above, substantially the same advantages as those of the embodiment described above and the modified example described above can be obtained.

### 5. Third Modified Example

Then, a laser interferometer and a method of adjusting the optical axis thereof according to a third modified example of the embodiment described above will be described.

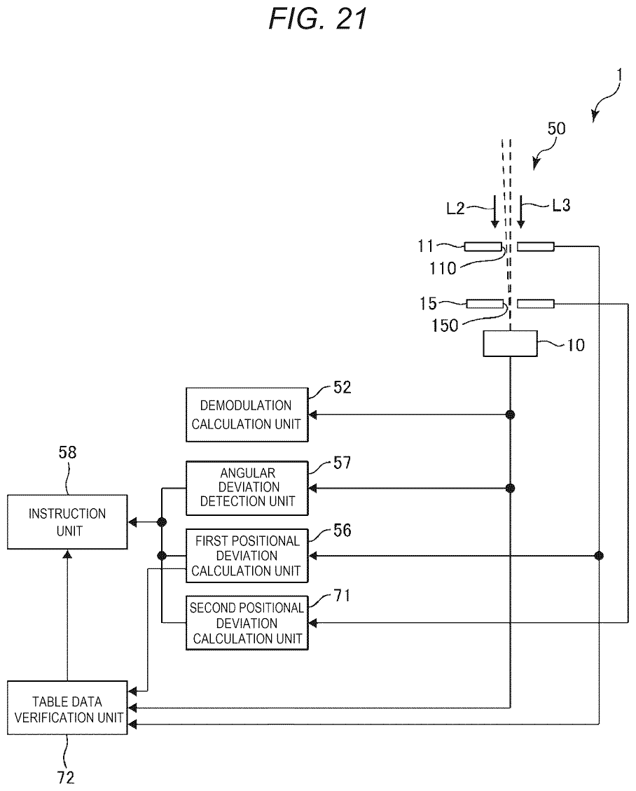

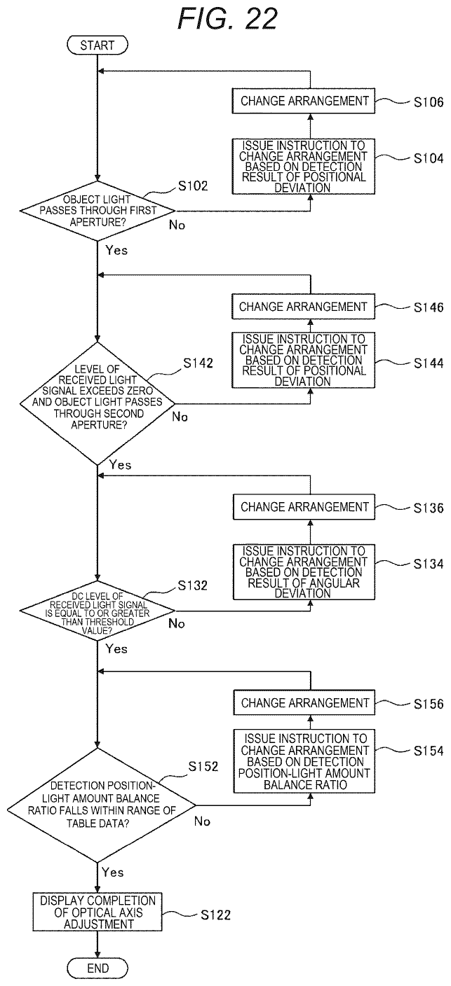

FIG. 21 is a schematic configuration diagram showing a part of the interference optical system 50 provided to the laser interferometer 1 according to the third modified example. FIG. 22 is a flowchart representing a configuration of the method of adjusting the optical axis of the laser interferometer according to the third modified example.

The third modified example will hereinafter be described, and in the following description, differences from the embodiment described above or the modified examples described above will mainly be described, and a description of substantially the same matters will be omitted. It should be noted that in the drawings of the present modified example, substantially the same constituents as those of the embodiment described above or the modified example described above are denoted by the same reference symbols.

The laser interferometer 1 according to the third modified example is substantially the same as the laser interferometer 1 according to the second modified example except that a table data verification unit 72 shown in FIG. 21 is provided.

The table data verification unit 72 has table data in which ratios between positions (detection positions) of the object light L3 detected by the first aperture element 11 and balances (light amount balances) between an amount of the object light L3 detected by the first aperture element 11 and an amount of light detected by the light receiving element 10 are recorded. These ratios are each hereinafter referred to as a “detection position-light amount balance ratio.”

As shown in a left diagram of FIG. 20, when there is no angular deviation, the detection position-light amount balance ratio is uniquely determined for each detection position. Therefore, the table data verification unit 72 shown in FIG. 21 performs processing of acquiring the detection position-light amount balance ratio and then verifying the detection position-light amount balance ratio thus acquired with the table data. Thus, the presence or absence of an angular deviation can be verified. Such verification is useful when distinguishing between the state of the left diagram and the state of a center diagram in FIG. 20 from each other. The state of the left diagram and the state of the center diagram in FIG. 20 cannot be distinguished from each other even in each of the determinations in steps S102, S142, and S132 in the second modified example described above. In contrast, by adding the verification by the table data verification unit 72, it becomes possible to distinguish these from each other.

Specifically, since the detection position-light amount balance ratio when there is no angular deviation is uniquely determined as described above, the values thereof are stored as the table data in the table data verification unit 72. Then, when the detection position-light amount balance ratio acquired falls within a range of the table data, the table data verification unit 72 assumes that there is no angular deviation. Such a state corresponds to, for example, the state in the left diagram of FIG. 20. On the other hand, when the detection position-light amount balance ratio acquired is out of the range of the table data, the table data verification unit 72 assumes that there is an angular deviation. Such a state corresponds to, for example, the state in the center diagram of FIG. 20.

When the table data verification unit 72 performs the processing described above, it is possible to distinguish between the state in the left diagram and the state in the center diagram of FIG. 20. As a result, it is possible to perform the optical axis adjustment while excluding the state in the center diagram of FIG. 20, that is, the state in which the interference fringe can be generated.

The instruction unit 58 shown in FIG. 21 issues the instruction to change the arrangement based on the calculation result by the first positional deviation calculation unit 56, the calculation result by the second positional deviation calculation unit 71, the detection result by the angular deviation detection unit 57, and the verification result by the table data verification unit 72.

Further, the method of adjusting the optical axis of the laser interferometer according to the third modified example is the same as the method of adjusting the optical axis of the laser interferometer according to the second modified example except that steps S152, S154, and S156 are added.

Steps S102 to S136 shown in FIG. 22 are substantially the same as those in FIG. 19.

In step S152 shown in FIG. 22, whether the detection position-light amount balance ratio acquired by the table data verification unit 72 falls within the range of the table data is verified. The detection position-light amount balance ratio is a ratio between the position (detection position) of the object light L3 detected by the first aperture element 11 and the balance (light amount balance) between the amount of the object light L3 detected by the first aperture element 11 and the amount of the light detected by the light receiving element 10, and can therefore be calculated based on the values acquired from the first positional deviation calculation unit 56, the first aperture element 11, and the light receiving element 10. Then, when the verification results in acceptance (Yes), the process proceeds to step S122. On the other hand, when the verification results in failure (No), the process proceeds to step S154.

In step S154, the instruction unit 58 issues the instruction to change the arrangement based on the detection position-light amount balance ratio. As the content of the instruction, there can be cited, for example, a difference between the detection position-light amount balance ratio acquired in real time and the range of the table data.

In step S156, the user changes the arrangement in accordance with the instruction. For example, the difference between the left diagram and the center diagram in FIG. 20 is mainly caused by the difference in optical distance Lsam shown in FIG. 11 and FIG. 12. Therefore, it is sufficient to change the optical distance Lsam to make the detection position-light amount balance ratio fall within the range of the table data. Accordingly, it is possible to efficiently change the arrangement in a direction of reducing the angular deviation. Subsequently, the process returns to step S152.

In such a third modified example as described above, substantially the same advantages as those of the embodiment described above and the modified examples described above can be obtained.

### 6. Fourth Modified Example

Then, a laser interferometer according to a fourth modified example of the embodiment described above will be described.

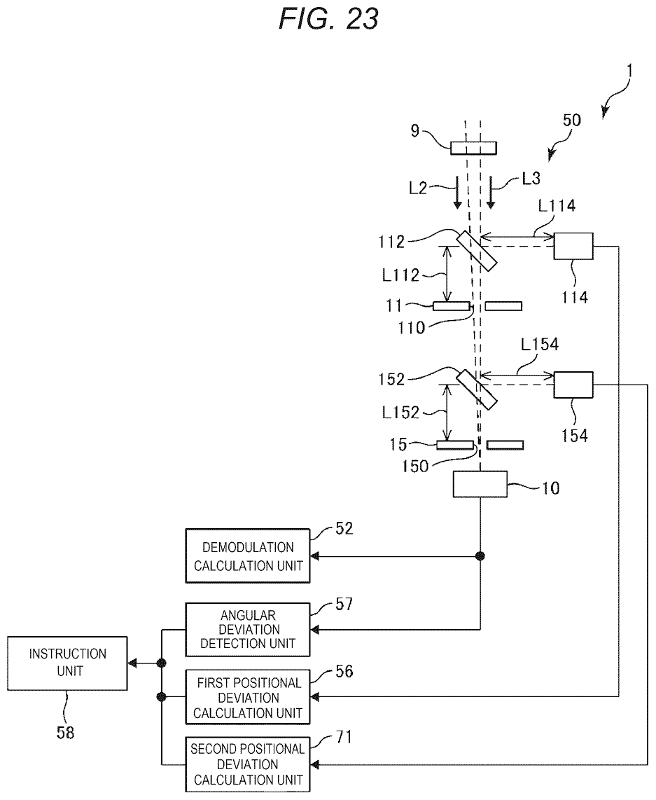

FIG. 23 is a schematic configuration diagram showing a part of the interference optical system 50 provided to the laser interferometer 1 according to the fourth modified example.

The fourth modified example will hereinafter be described, and in the following description, differences from the embodiment described above or the modified examples described above will mainly be described, and a description of substantially the same matters will be omitted. It should be noted that in the drawings of the present modified example, substantially the same constituents as those of the embodiment described above or the modified example described above are denoted by the same reference symbols.

The laser interferometer 1 according to the fourth modified example is substantially the same as the laser interferometer 1 according to the second modified example except that half mirrors 112, 152 and cameras 114, 154 shown in FIG. 23 are provided.

The half mirror 112 is disposed between the analyzer 9 and the first aperture element 11, and branches a part of each of the amounts of the reference light L2 and the object light L3. The camera 114 acquires a two-dimensional image of a part of each of the amounts of the reference light L2 and the object light L3 branched by the half mirror 112. Each pixel of the image has luminance information. Therefore, it is possible to detect the positions of the optical axes of the reference light L2 and the object light L3 from the images. Accordingly, the half mirror 112 and the camera 114 can substitute the function of the first aperture element 11.

It should be noted that an optical distance L114 between the half mirror 112 and the camera 114 is kept equal to an optical distance L112 between the half mirror 112 and the first aperture element 11. Accordingly, the positional deviation in the first aperture element 11 can be reproduced on the image.

The half mirror 152 is disposed between the first aperture element 11 and the second aperture element 15, and branches a part of each of the amounts of the reference light L2 and the object light L3. The camera 154 acquires a two-dimensional image of a part of each of the amounts of the reference light L2 and the object light L3 branched by the half mirror 152. Each pixel of the image has luminance information. Therefore, it is possible to detect the positions of the optical axes of the reference light L2 and the object light L3 from the images. Accordingly, the half mirror 152 and the camera 154 can substitute the function of the second aperture element 15.

It should be noted that an optical distance L154 between the half mirror 152 and the camera 154 is kept equal to an optical distance L152 between the half mirror 152 and the first aperture element 11. Accordingly, the positional deviation in the second aperture element 15 can be reproduced on the image.

In such a fourth modified example as described above, substantially the same advantages as those of the embodiment described above and the modified examples described above can be obtained. In addition, the fourth modified example is useful in that it is possible to more sensuously change the arrangement since the positional deviation can be reproduced on the image. Further, the half mirror 112 and the camera 114 are also applicable to the interference optical system 50 shown in FIG. 2, FIG. 14, FIG. 17, and FIG. 21.

### 7. Fifth Modified Example

Then, a laser interferometer according to a fifth modified example of the embodiment described above will be described.

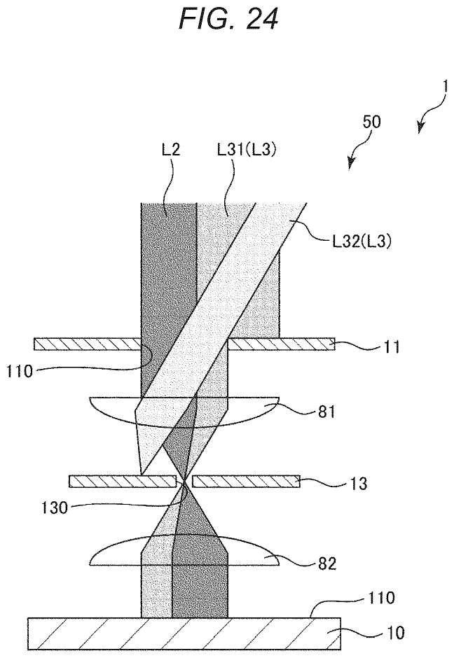

FIG. 24 is a schematic configuration diagram showing a part of the interference optical system 50 provided to the laser interferometer 1 according to the fifth modified example.

The fifth modified example will hereinafter be described, and in the following description, differences from the embodiment described above or the modified examples described above will mainly be described, and a description of substantially the same matters will be omitted. It should be noted that in the drawings of the present modified example, substantially the same constituents as those of the embodiment described above or the modified example described above are denoted by the same reference symbols.

The laser interferometer 1 according to the fifth modified example is substantially the same as the laser interferometer 1 according to the first modified example except that a condenser lens 81 and a collimator lens 82 (collimating lens) shown in FIG. 24 are provided.

The condenser lens 81 is disposed between the first aperture element 11 and the aperture 13, and makes the reference light L2 which has passed through the first aperture 110 converge on the through hole 130. Accordingly, the reference light L2 which has been condensed can pass through the through hole 130. That is, the condenser lens 81 is arranged so that the reference light L2 perpendicularly enters the principal plane of the condenser lens 81, and converges on the through hole 130. In addition, it is preferable that the aperture size of the through hole 130 is made smaller than that of the first modified example to the extent that the reference light L2 which has been condensed can pass through the through hole 130.

Further, the object light L3 having no angular deviation from the reference light L2 is referred to as “object light L31.” The condenser lens 81 makes the object light L31 having passed through the first aperture 110 converge on the through hole 130. Accordingly, the object light L31 having been condensed can also pass through the through hole 130.

In contrast, the object light L3 which has an angular deviation from the reference light L2 is referred to as “object light L32.” The object light L32 having passed through the first aperture 110 enters the condenser lens 81 at an angle inclined with respect to the principal plane, and therefore does not converge on the through hole 130 but is blocked by the aperture 13.

Therefore, the object light L32 can more reliably be blocked by providing the condenser lens 81. As a result, it is possible to make only the object light L31 having a small angular deviation reach the light receiving element 10. Accordingly, for example, it is possible to distinguish the state in the left diagram in FIG. 20 and the state in the center diagram from each other. Specifically, the state in the left diagram of FIG. 20 is a state in which the object light L31 passes through the first aperture 110. Therefore, when the condenser lens 81 is added to the left diagram of FIG. 20, the object light L31 can pass through the through hole 130 after being condensed by the condenser lens 81. In contrast, the state in the center diagram of FIG. 20 is a state in which the object light L32 passes through the first aperture 110. Accordingly, when the condenser lens 81 is added to the center diagram of FIG. 20, the object light L32 fails to pass through the through hole 130 even when the object light L32 is condensed by the condenser lens 81. Therefore, the object light L32 fails to reach the light receiving element 10. This makes it possible to more reliably prevent the occurrence of the interference fringe.

Further, the collimator lens 82 is disposed between the aperture 13 and the light receiving element 10, and restores the reference light L2 and the object light L31 which have passed through the through hole 130 to parallel light, and makes the light receiving element 10 receive the parallel light. Accordingly, a both-side telecentric optical system can be constructed together with the condenser lens 81. That is, it is possible to make the reference light L2 and the object light L31 which have been parallel light converge with the condenser lens 81, and then restore the reference light L2 and the object light L31 to parallel light once again with the collimator lens 82. As a result, it becomes hard for the interference condition to be broken in the light receiving element 10. It should be noted that it is sufficient for the collimator lens 82 to be provided as needed, and it is possible to omit the collimator lens 82.

In such a fifth modified example as described above, substantially the same advantages as those of the embodiment described above and the modified examples described above can be obtained.

### 8. Advantages Exerted by Embodiment

As described above, the laser interferometer 1 according to the embodiment described above includes the interference optical system 50 (optical interference unit) which is a non-coaxial optical system, and the instruction unit 58. The interference optical system 50 includes the laser source 2, the light modulator 12, the light receiving element 10, the first aperture element 11, and the angular deviation detection unit 57. The laser source 2 emits the outgoing light L1 (laser beam). The light modulator 12 modulates the frequency of the outgoing light L1 to generate the reference light L2. The light receiving element 10 receives the object light L3 which is generated by irradiating the object 14 with the outgoing light L1, and the reference light L2, and outputs the received light signal. The first aperture element 11 is disposed on a light path 24 of the object light L3 and the reference light L2 which enter the light receiving element 10, and detects the positional deviation of the optical axis of the object light L3 from the optical axis of the reference light L2. The angular deviation detection unit 57 detects the angular deviation of the optical axis of the object light L3 from the optical axis of the reference light L2 based on the received light signal. The instruction unit 58 issues an instruction to change the relative arrangement between the interference optical system 50 and the object 14 based on the detection result of the positional deviation and the detection result of the angular deviation.

According to such a configuration, it is possible to achieve the elimination of both the positional deviation and the angular deviation based on the relationship between the positional deviation or the angular deviation and the influence caused by the positional deviation or the angular deviation. That is, it is possible to help the user adjust the optical axis to prevent the generation of the non-interference region due to the positional deviation, and prevent the generation of the interference fringe due to the angular deviation. Accordingly, even when the non-coaxial optical system is adopted, it is possible to achieve the prevention of the decrease in S/N ratio in the received light signal, and it is possible to realize the laser interferometer 1 high in measurement accuracy with respect to the object 14.

Further, the first aperture element 11 includes the first aperture 110 and the light detection areas 11A, 11B, 11C, and 11D. The reference light L2 and the object light L3 pass through the first aperture 110. The light detection areas 11A, 11B, 11C, and 11D are disposed at positions adjacent to the first aperture 110, and detect the object light L3 the optical axis of which deviates in position from the optical axis of the reference light L2.

According to such a configuration, it is possible to detect the positional deviations of the reference light L2 and the object light L3 in the first aperture element 11. Then, the positional deviation can efficiently be corrected by changing the arrangement based on the detection result.

Further, the instruction unit 58 can be configured to instruct a relative displacement direction of the interference optical system 50 (optical interference unit) with respect to the object 14.

According to such a configuration, the user can easily change the arrangement in accordance with the instruction, and can efficiently adjust the optical axis.

Further, the laser interferometer 1 according to the embodiment described above includes the aperture 13. The aperture 13 is disposed between the first aperture element 11 and the light receiving element 10. The aperture 13 includes the through hole 130 through which the reference light L2 and the object light L3 having passed through the first aperture 110 pass.

According to such a configuration, the object light L3 in which no angular deviation occurs can pass through both the first aperture 110 and the through hole 130 to reach the light receiving element 10. Therefore, the angular deviation can be detected based on the DC level of the received light signal. Accordingly, the user can intuitively and accurately grasp the degree of the angular deviation.

Further, the laser interferometer 1 according to the embodiment described above includes the condenser lens 81. The condenser lens 81 is disposed between the first aperture element 11 and the aperture 13, and makes the reference light L2 and the object light L3 having passed through the first aperture 110 converge on the through hole 130.

According to such a configuration, it is possible to more reliably block the object light L32 having an angular deviation with respect to the reference light L2. Accordingly, it is possible to make only the object light L31 small in angular deviation reach the light receiving element 10. As a result, the occurrence of the interference fringe can more reliably be prevented.

Further, the laser interferometer 1 according to the embodiment described above includes the collimator lens 82 (collimating lens). The collimator lens 82 is disposed between the aperture 13 and the light receiving element 10, and collimates the reference light L2 and the object light L3 having passed through the through hole 130.

According to such a configuration, it is possible to restore the reference light L2 and the object light L31 which have once converged to the parallel light.

Further, the laser interferometer 1 according to the embodiment described above includes the second aperture element 15. The second aperture element 15 is disposed between the first aperture element 11 and the light receiving element 10. The second aperture element 15 detects a positional deviation of the optical axis of the object light L3 having passed through the first aperture 110 from the optical axis of the reference light L2 having passed through the first aperture 110.

According to such a configuration, it is possible to detect the direction of the positional deviation of the optical axis of the object light L3 with respect to the optical axis of the reference light L2 passing through the second aperture 150 based on the detection result in the second aperture element 15. Accordingly, it is possible to efficiently correct the angular deviation.

Further, the method of adjusting the optical axis of the laser interferometer according to the embodiment described above is a method of adjusting the optical axis of the laser interferometer 1 including the interference optical system 50 (optical interference unit) which is a non-coaxial optical system. The interference optical system 50 includes the laser source 2, the light modulator 12, the light receiving element 10, the first aperture element 11, and the angular deviation detection unit 57. The laser source 2 emits the outgoing light L1 (laser beam). The light modulator 12 modulates the frequency of the outgoing light L1 to generate the reference light L2. The light receiving element 10 receives the object light L3 which is generated by irradiating the object 14 with the outgoing light L1, and the reference light L2, and outputs the received light signal. The first aperture element 11 is disposed on a light path 24 of the object light L3 and the reference light L2 which enter the light receiving element 10, and detects the positional deviation of the optical axis of the object light L3 from the optical axis of the reference light L2. The angular deviation detection unit 57 detects the angular deviation of the optical axis of the object light L3 from the optical axis of the reference light L2 based on the received light signal.

Further, the method of adjusting the optical axis of the laser interferometer according to the embodiment described above includes issuing an instruction to change the relative arrangement of the interference optical system 50 and the object 14 based on the detection result of the positional deviation and the detection result of the angular deviation, and changing the arrangement based on the instruction.

According to such a configuration, it is possible to easily achieve the elimination of both the positional deviation and the angular deviation based on the relationship between the positional deviation and the angular deviation and the influence caused by those deviations. That is, it is possible to help the user adjust the optical axis to prevent the generation of the non-interference region due to the positional deviation, and it is possible to easily perform the work of preventing the generation of the interference fringe due to the angular deviation. Accordingly, even when the non-coaxial optical system is used in the laser interferometer 1, the optical axis can efficiently be adjusted.

Although the laser interferometer according to the present disclosure is hereinabove described based on the illustrated embodiment, the laser interferometer according to the present disclosure is not limited to the embodiment described above, and the configuration of each unit can be replaced with any configuration having substantially the same function. Further, any other constituents can be added to the laser interferometer according to the embodiment described above.

The laser interferometer according to the present disclosure can be applied to, for example, a vibration meter, an inclinometer, and a distance meter (a length measuring device) in addition to the displacement gauge or the speed meter described above. In addition, as the usage of the laser interferometer according to the present disclosure, there can be cited an optical comb interference measurement technique that enables distance measurement, 3D imaging, spectroscopy, and so on, an optical fiber gyro that implements an angular velocity sensor, an angular acceleration sensor, and so on, and a Fourier spectrometer including a moving mirror device, and so on.

Further, two or more of the light source, the light modulator, and the light receiving element can be mounted on the same substrate. Accordingly, it is possible to easily achieve the reduction in size and weight of the interference optical system, and to enhance the ease of assembly.

Further, although the embodiment described above has a so-called Michelson interference optical system, the laser interferometer according to the present disclosure is also applicable to an interference optical system of another type such as a Mach-Zehnder interference optical system.

What is claimed is:

1. A laser interferometer comprising:
an optical interference unit as a non-coaxial optical system including
a laser source configured to emit a laser beam,
a light modulator that is configured to modulate a frequency of the laser beam to generate reference light,
a light receiving element configured to receive object light generated in response to irradiation of an object with the laser beam, and the reference light to output a received light signal,
a first aperture element disposed on a light path through which the object light and the reference light enter the light receiving element, and configured to detect a positional deviation of an optical axis of the object light from an optical axis of the reference light, and
an angular deviation detection unit configured to detect an angular deviation of the optical axis of the object light from the optical axis of the reference light based on the received light signal; and
an instruction unit configured to issue an instruction to change a relative arrangement between the optical interference unit and the object based on a detection result of the positional deviation detected by the angular deviation detection unit and a detection result of the angular deviation detected by the angular deviation detection unit.

2. The laser interferometer according to claim 1, wherein
the first aperture element includes
a first aperture through which the reference light and the object light pass, and
a light detection area that is disposed at a position adjacent to the first aperture, and configured to detect the object light the optical axis of which deviates in position from the optical axis of the reference light.

3. The laser interferometer according to claim 1, wherein
the instruction unit is configured to instruct a relative displacement direction of the optical interference unit to the object.

4. The laser interferometer according to claim 1, further comprising:
an aperture disposed between the first aperture element and the light receiving element, wherein
the aperture includes a through hole through which the reference light and the object light that passed through the first aperture pass.

5. The laser interferometer according to claim 4, further comprising:
a condenser lens disposed between the first aperture element and the aperture, and configured to make the reference light and the object light that passed through the first aperture converge on the through hole.

6. The laser interferometer according to claim 5, further comprising:
a collimator lens disposed between the aperture and the light receiving element, and configured to collimate the reference light and the object light that passed through the through hole.

7. The laser interferometer according to claim 1, further comprising:
a second aperture element disposed between the first aperture element and the light receiving element, wherein
the second aperture element is configured to detect a positional deviation of the optical axis of the object light that passed through the first aperture from the optical axis of the reference light that passed through the first aperture.

8. A method of adjusting an optical axis of a laser interferometer including
an optical interference unit as a non-coaxial optical system including
a laser source configured to emit a laser beam,
a light modulator that is configured to modulate a frequency of the laser beam to generate reference light,
a light receiving element configured to receive object light generated in response to irradiation of an object with the laser beam, and the reference light to output a received light signal,
a first aperture element disposed on a light path through which the object light and the reference light enter the light receiving element, and configured to detect a positional deviation of an optical axis of the object light from an optical axis of the reference light, and
an angular deviation detection unit configured to detect an angular deviation of the optical axis of the object light from the optical axis of the reference light based on the received light signal, the method comprising:
issuing an instruction to change a relative arrangement between the optical interference unit and the object based on a detection result of the positional deviation and a detection result of the angular deviation; and
changing the arrangement based on the instruction.
